(19) United States
(12) Patent Application Publication
(10) Pub. No.: US 2018/0308151 A1
(43) Pub. Date: Oct. 25, 2018

(54) ENHANCING REVENUE OF A RETAILER BY MAKING A RECOMMENDATION TO A CUSTOMER

(71) Applicant: Comenity LLC, Columbus, OH (US)

(72) Inventors: Richard Barber AINSWORTH, III, Dublin, OH (US); Christine HARDIN, Blacklick, OH (US); Thom-Austin YOUNG, Westerville, OH (US); Daniel Paul FINKELMAN, Granville, OH (US); Dean Lawrence KOWALSKI, New Albany, OH (US)

(73) Assignee: Comenity LLC, Columbus, OH (US)

(21) Appl. No.: 16/022,379

(22) Filed: Jun. 28, 2018

Related U.S. Application Data
(63) Continuation of application No. 14/335,830, filed on Jul. 18, 2014.
Application No. 14/335,830 is a division of application No. 13/843,651, filed on Mar. 15, 2013, now abandoned.

(51) Int. Cl. G06Q 30/06

(52) U.S. Cl. CPC G06Q 30/0631

(57) ABSTRACT

A retailer's revenue may be enhanced by recommending items in context of a specific collection built for a customer's specific preferences. Customer input that pertains to their previously purchased items and future preferences is received. The input that pertains to the customer is analyzed. A recommendation for the customer is dynamically generated that includes a collection of coordinated items that provides a personalized ensemble based on the input.

### CROSS REFERENCE TO RELATED APPLICATIONS

The present patent application is a Continuation Application of and claims the benefit of co-pending U.S. patent application Ser. No. 14/335,830, filed Jul. 18, 2014, entitled “Enhancing Revenue of a Retailer by Making a Recommendation to a Customer,” by Ainsworth et al., Atty docket No. ADS-001.DIV, assigned to the assignee of the present application which is incorporated in its entirety herein.

U.S. patent application Ser. No. 14/335,830 is a Divisional Application of and claims the benefit of U.S. patent application Ser. No. 13/843,651, filed Mar. 15, 2013, entitled “Enhancing Revenue of a Retailer by Making a Recommendation to a Customer,” by Ainsworth et al., Atty docket No. ADS-001, assigned to the assignee of the present application which is incorporated in its entirety herein.

### BACKGROUND

Apparel customers often shop in a store with the intention to either make a specific purchase or to view garments that complement each other. Quite often, these customers are interested in purchasing items that can be worn together to create an outfit. For example, when a person is interested in purchasing a pair of pants, they may be interested in matching those pants with a particular shirt that they either already own or that they will purchase. From the perspective of a retailer, encouraging the purchase of additional items that, together, form an ensemble is beneficial to increase the customer's spend. Product suggestion is nothing new. Attempts are frequently made by retailers to entice additional purchases by customers. However, to date, the majority of automatic recommendations are based on purchase combinations but importantly, consumers don't always wear together what they buy together. As one example, stores typically display ensembles to potential customers on mannequins. The ensembles displayed on the mannequins are typically determined from instructions (i.e., mannequin cards, style cards, etc. . . . ) provided by the apparel Merchant or Buyer. Most of the stores that sell that retailer's clothing will dress their respective mannequins to conform to the merchant's instruction. The ensembles depicted on the mannequin cards are intended to highlight the trends of the season, as well as the retailer's most current product offering, but are not customized to an individual's specific and/or unique preferences.

In a second example of retailers attempting to entice further purchases, high end stores sometimes provide the services of a personal shopper to help customers select clothing. The personal shopper may talk with a customer about their clothing preferences and physically walk back and forth between the floor to obtain different pieces of clothing and the dressing room to hand the obtained pieces of clothing to the customer to try on. The live personal shopper process is subjective, intuitive, expensive and time consuming. Further, it is generally only cost effective for expensive items.

A third example of retailers attempting to entice customers to purchase additional items involves online vendors. However, these approaches generally recommend individual items with varying consumer usefulness. For example, when using certain online vendors, if a customer is, for example, browsing for a shirt, even after the customer has purchased a shirt, that customer may be presented with other similar shirts. Further, they may be presented with complementary items, such as a skirt, that may or may not form an attractive ensemble from the customer's specific point of view. Of greater benefit to the customer is to see a variety of shirts presented with other items (skirts, shoes, handbags, glasses, . . . ) in the form of an ensemble. By providing the context of the full outfit, the customer can be more confident their purchase will be satisfying. This confidence leads to greater chance of additional purchases, willingness to pay, and significantly improved satisfaction about the purchase. In using the customer's purchase history, if available, the recommendations suggest items that will likely have greater appeal to that particular customer. Providing detailed and personalized recommendations can increase the customer's loyalty to the retailer and feel that the retailer truly knows their aesthetic. This increased loyalty will likely translate to more frequent trips to the retailer and a greater overall spend.

For example: where a customer may be reluctant to buy a trendy skirt as an individual item, he or she may be pleasantly surprised by how appealing it looks with as a complete outfit provided through a recommendation with several apparel and accessory items shown together.

### BRIEF DESCRIPTION OF THE DRAWINGS

The accompanying drawings, which are incorporated in and form a part of this Description of Embodiments, illustrate various embodiments of the present invention and, together with the description, serve to explain principles discussed below:

FIG. 1 depicts a block diagram of relationships between a collection recommendation system, a user interface, a system providing business, a retailer and retail customers, according to one embodiment.

FIGS. 2-39 depict pages of a user interface, according to various embodiments.

FIG. 40 depicts a block diagram of a collection recommendation system, according to one embodiment.

FIGS. 41-43 depict flow charts of methods for enhancing a retailer's revenue by making a recommendation to a customer, according to various embodiments.

The drawings referred to in this Brief Description should not be understood as being drawn to scale unless specifically noted.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in the following Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Unless specifically stated otherwise as apparent from the following discussions, it is appreciated that throughout the description of embodiments, discussions utilizing terms such as “enhancing,” “making,” “receiving,” “analyzing,” “generating,” “providing,” “accessing,” “building,” “displaying,” “offering,” “specifying,” “associating,” “adding,” “suggesting,” “determining,” “using,” “designing,” “charging,” “motivating,” “presenting,” “increasing,” “coordinating,” “transforming data,” “modifying data to transform the state of a computer system,” or the like, refer to the actions and processes of a computer system, data storage system, storage system controller, microcontroller, processor, or similar electronic computing device or combination of such electronic computing devices. The computer system or similar electronic computing device manipulates and transforms data represented as physical (electronic) quantities within the computer system's/device's registers and memories into other data similarly represented as physical quantities within the computer system's/device's memories or registers or other such information storage, transmission, or display devices.

According to one embodiment, a recommendation for a customer is dynamically generated where the recommendation includes a collection of items that provides a personalized ensemble. A recommendation can be provided at a price that the customer can afford to buy even an inexpensive item that is recommended and can be provided in near real time.

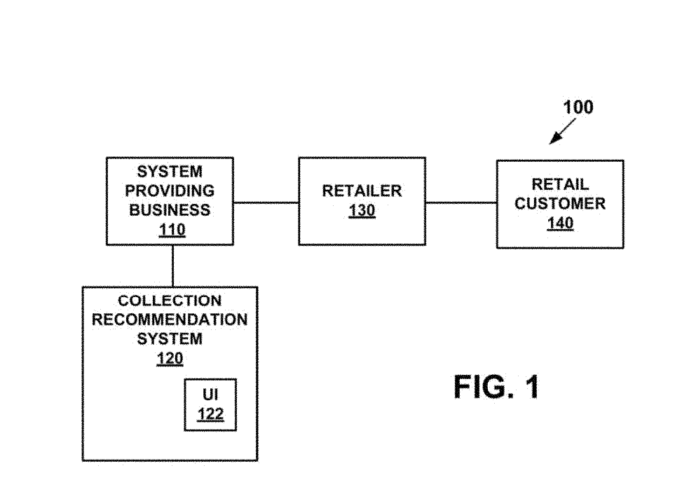

FIG. 1 depicts a block diagram of relationships 100 between a collection recommendation system 120, a user interface 122, a system providing business 110, a retailer 130 and retail customers 140 (also referred to herein as “customers”), according to one embodiment.

According to one embodiment, the collection recommendation system 120 is provided by a business 110 (also referred to herein as a “system providing business”) that has access to information for a multitude of retailers 130 and customers 140. Examples of retailers in the apparel industry are J. Crew, Talbot, and Macy's. According to one embodiment, the system providing business 110 is a credit card financing business that provides credit cards (referred to herein as “private labeled credit cards”) with different retailer labels for each of the retailers 130. For example, the system providing business 110 can provide a Macy's credit card for Macy's, a Talbot credit card for Talbot and a J. Crew credit card for J. Crew. The system providing business 110 can obtain information pertaining to customers 140 when the customers 140 apply for the private labeled credit cards, such as one or more of their names, their email addresses, their ages, their incomes, where they live, how many children they own, their types of employment, the names of their businesses.

According to various embodiments, input that pertains to a customer 140 can be received by the collection recommendation system 120. Examples of the input are input from the one or more retailers, more general customer input, finer grained customer input pertaining to customer's preferences on individual items, empirical data, and information about other customers that are similar to a customer, as will become more evident. The system providing business 110 may have the input that pertains to the customer 140 or a subset thereof, or be able to obtain the input that pertains to the customer 140, or a subset thereof, from the retailers 130.

A user, such as a customer 140, can interact with the collection recommendation system 120 through a user interface 122 to dynamically generate a recommendation that includes a collection of items that provides a personalized ensemble, for example, for the customer 140.

Although various embodiments are illustrated with a customer 140 interacting with a user interface 122 of a collection recommendation system 120, various embodiments are well suited for other types of users interacting with the user interface 122, such as a personal shopper, a retailer, a publisher, among others. Various embodiments are illustrated with items of apparel. However, various embodiments are well suited to other types of items, such as items of furniture. For example, various embodiments are well suited for dynamically generating a collection of furniture items that provide a recommendation of a personalized ensemble of furniture for a customer's room. Various embodiments are well suited for generating recommendations for hypothetical customers that can be published, for example, in a magazine or on a web page, among others.

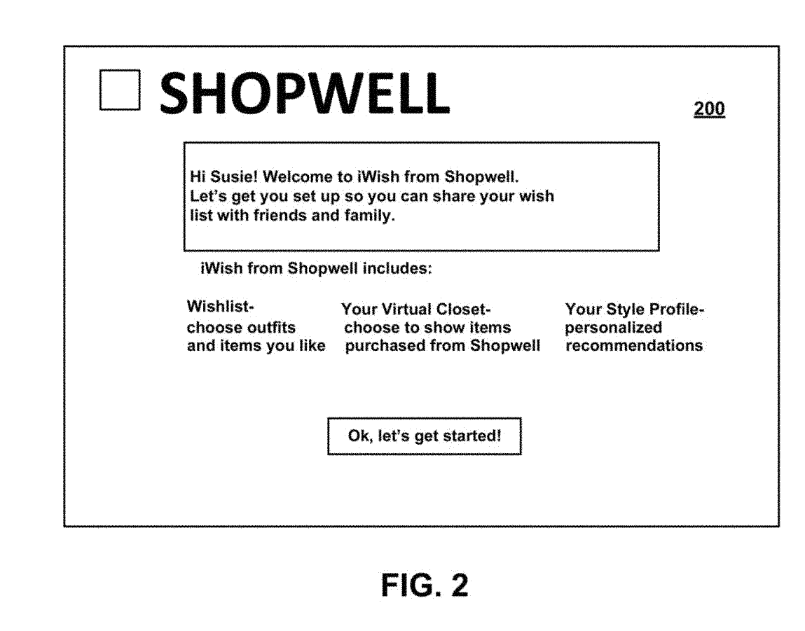

FIG. 2 depicts a page 200 for welcoming a customer to a user interface for a collection recommendation system, according to various embodiments.

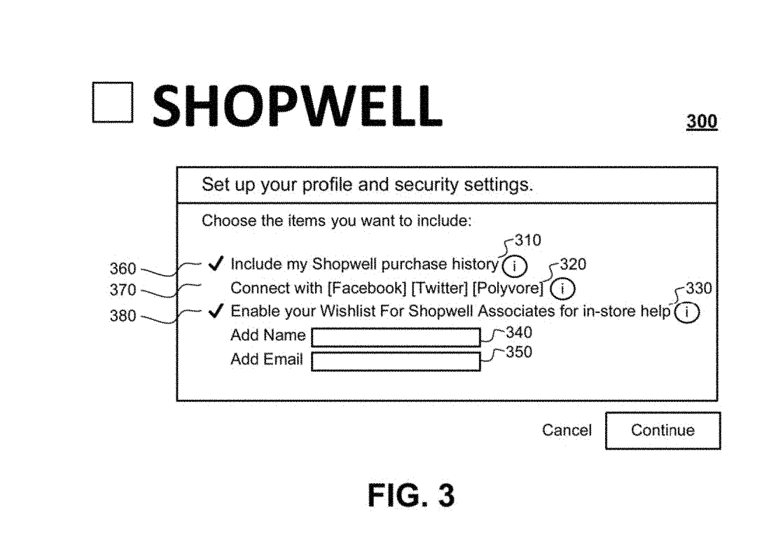

FIG. 3 depicts a page 300 for setting up the customer's profile and security settings in preparation of dynamically generating collections, according to various embodiments.

The page 300 allows the customer to determine items that they want to include in their experience with the user interface, such as their purchase history 310, a social media 320, such as Facebook, Twitter, or Polyvore, whether to enable their wishlist 330 for employees associated with the collection recommendation system. The page 300 may allow the customer to add their name 340 and their email address 350.

Boxes 360, 370, 380 can be associated with their purchase history 310, social media 320, and wish list 330 to indicate which of the options 310, 320, 330 the customer has chosen. As depicted in FIG. 3, the boxes 360 and 380 are checked indicating that the customer has selected their purchase history 310 and wish list 330.

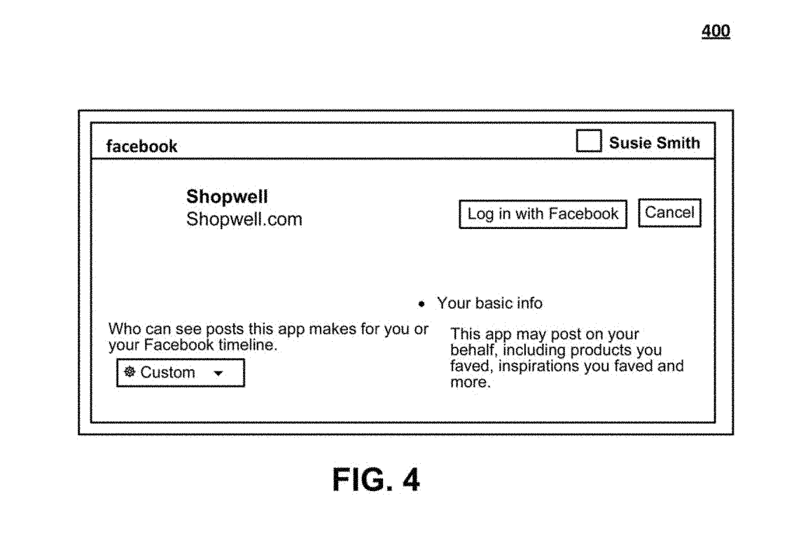

FIG. 4 depicts a page 400 for logging into a specified social media, such as Facebook, according to one embodiment, so that the collection recommendation system can receive information, for example, about items that can be included in a collection from the specified social media.

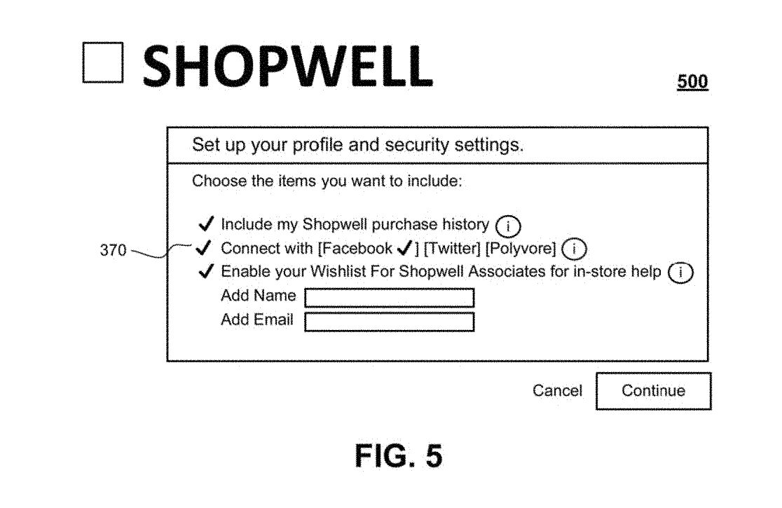

FIG. 5 depicts a page 500 indicating that the connection between the specified social media and the collection recommendation system has been established, according to one embodiment.

The box 370 next to the text for connecting with social media indicates that a connection between Facebook has been established.

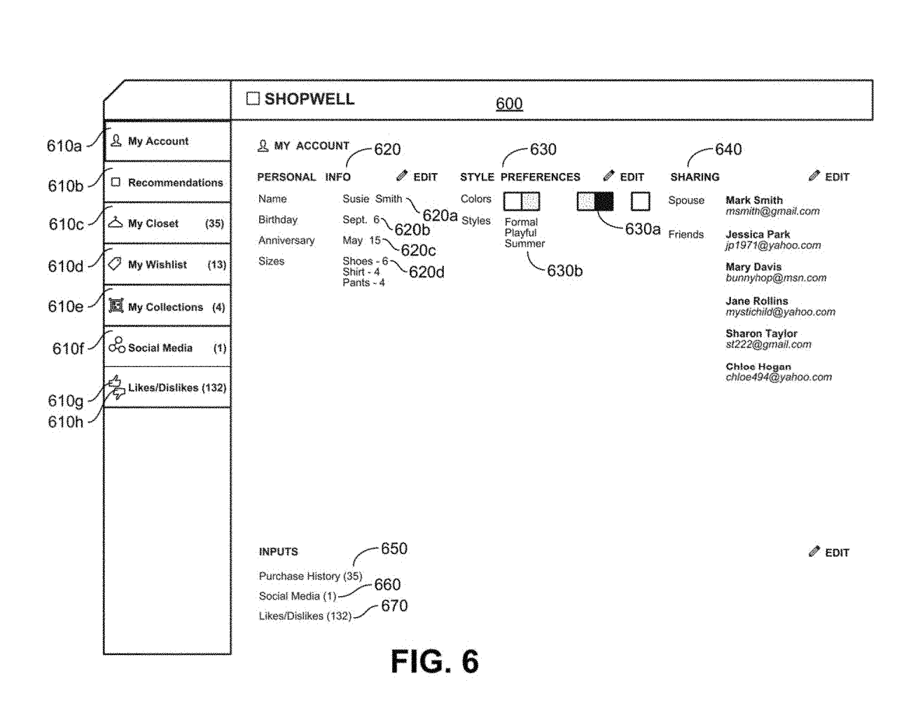

FIG. 6 depicts a page 600 for the customer's account information, according to one embodiment.

According to one embodiment, the page 600 depicts the various pieces of customer's input. Examples of the customer's input include personal information 620, preferences 630, individuals or groups 640 the customer is interested in sharing information with, purchase history 650, social media 660, and likes and dislikes 670.

According to one embodiment, the customer can share the items that are in their wishlist with the individuals or groups 640. For example, by sharing their wish list with individuals or groups 640, the people associated with 640 may purchase items for the customer from the customer's wish list.

Examples of personal information 620 are the customer's name 620a, birth date 620b, wedding anniversary 620c, and sizes 620d of various types of apparel, such as shoe, shirt, pants, and dress, among others. According to one embodiment, the personal information 620 can include one or more measurements of parts of a customer's body, such as height, chest, waist, hips, inseam of their leg, neck, and arm length, among others.

Examples of preferences 630 are preferred colors 630a and preferred styles 630b. In this example, the colors 630a include dark blue, hunter green, light green, yellow, burnt orange, teal, tan, and chocolate brown and the styles 630b include formal, playful, and summer.

The page 600 has tabs 610a-610h on the side for accessing various pages of the user interface, such as the customer's account 610a (e.g., “My Account”), recommendations 610b of collections for the customer (e.g., “Recommendations”), the customer's closet 610c (e.g. “My Closet”), the customer's wish list 610d of items they desire to purchase (e.g., My Wishlist”), the customer's collections 610e (e.g., “My Collections”), the customer's social media 610f (e.g., “Social Media”), and the customer's likes 610g (e.g., “Likes”) and dislikes 610h (e.g., “Dislikes”) of specific items. The like tab 610g can be displayed as a thumbs up and the dislike tab 610h can be displayed as a thumbs down, according to one embodiment. According to one embodiment, the customer's collections under the collection tab 610e are collections that were recommended using the recommendation tab 610b and that the customer has accepted to become a part of their collections. The my account tab 610a is highlighted, according to one embodiment, because the customer selected it.

As depicted, there are 35 items in the customer's closet 610c, 13 items in the customer's wish list 610d, four collections 610e for the customer, one social media 610f, which in this illustration is Facebook, the customer has specified 132 likes and dislikes of specific items for tab 610g, and there are 35 items in the purchase history 650.

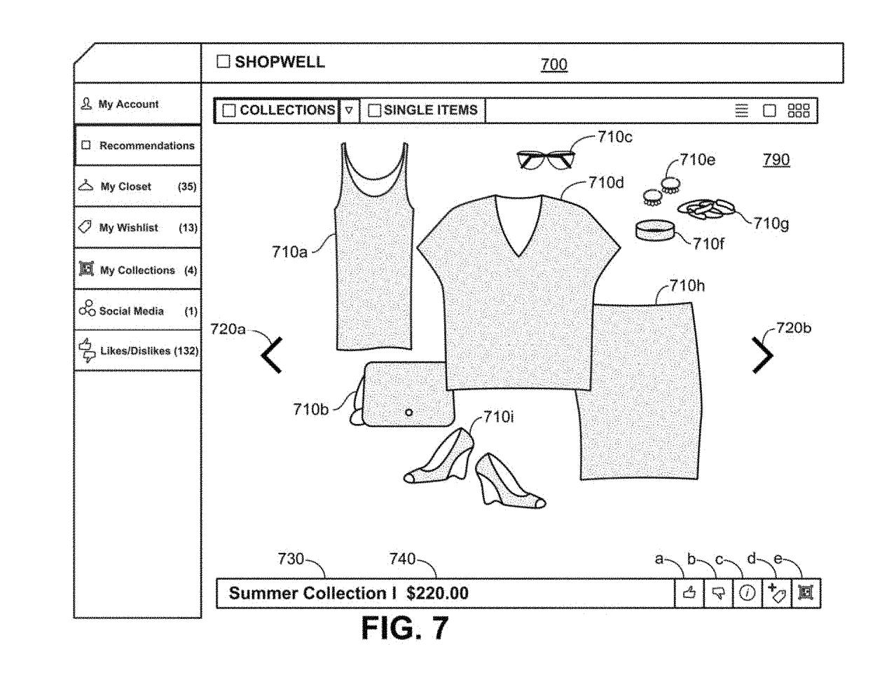

FIG. 7 depicts a page 600 with the highest ranked recommendation 790 for the customer, according to one embodiment.

The recommendations of collections are ranked based on potential appeal to the customer. The recommendation that potentially has the highest appeal to the customer is the highest ranked recommendation and can be displayed first, according to one embodiment.

The collection is a dynamically generated recommendation 790 for a customer that includes coordinated items 710a-710i that provides a personalized ensemble for the customer. For example, the depicted collection on FIG. 7 includes a tank top 710a, a horizontal striped shirt 710d that could be worn over the tank top, a skirt 710h, a pair of shoes 710i, sunglasses 710c, and jewelry, such as a pair of ear rings 710e, and bracelets 710f, 710g. The tank top 710a and shoes 710i are black. The horizontal striped shirt 710d has white and black horizontal stripes. The skirt 710h, purse 710b, the wide bracelet 710f and the ear rings 710e are teal with the skirt 710h and ear rings 710e being a darker shade of teal than the purse 710b and wide bracelet 710f The thin bracelets 710g have a gold finish. The sunglasses 710c have a tortoise shell rim. This is just one example of a generated recommendation that provides a personalized ensemble.

The page 700 can indicate the style 730 and price 740 of the recommendation 790. In this illustration, the collection is a summer collection and costs $220.00. According to one embodiment, the collection correlates with one of the styles that the customer indicated that they prefer on the page depicted on FIG. 5.

The items 710a-710i in the collection complements each other and provide a coordinated personalized ensemble for the customer. The personalized ensemble can be provided based on the input that pertains to the customer, according to one embodiment. For example, one of the customer's style preferences 630b (FIG. 6) is summer and the collection includes items for summer 730. In another example, the customer's preferred colors 630a (FIG. 6) include teal and the collection has items of various shades of teal that coordinate with each other. In a third example, the items of the collection are selected to conform to the customer's specified sizes 620d (FIG. 6). These are just a few examples of the input that pertains to the customer that can be used for dynamically generating a recommendation 790 that is a personalized ensemble.

The page 700 depicted on FIG. 7 displays various tabs 610a-610h on the left side, as discussed herein. The recommendations tab 610b is highlighted because the customer selected it.

The page 700 depicted on FIG. 7 displays various icons a-e, such as a like icon a, a dislike icon b, an information icon c, a wish list icon d, and collection icon e. These icons a-e are associated with any one or more pages or pop up windows as depicted on various pages of the collection recommendation system's user interface, as will become more evident. According to one embodiment, a like icon a may be displayed as a thumbs up, a dislike icon b may be displayed as a thumbs down, the information icon c may be displayed as the letter i inside of a circle, the wish list icon d may be displayed as a plus sign, and the collection icon e may approximate a square.

Page 700, according to one embodiment, has respective arrows 720a, 720b to enable a user to flip to a previous page or the next page.

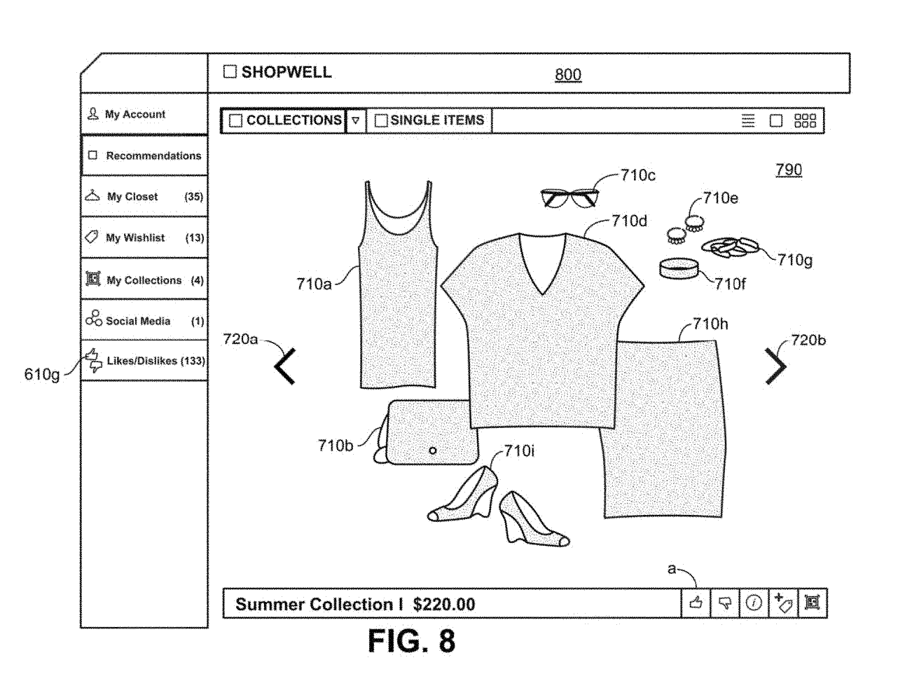

FIG. 8 depicts a page 800 with the highest ranked recommendation 790, according to one embodiment.

The page 800 depicted on FIG. 8 displays various tabs 610a-610h on the left side, as discussed herein. The recommendations tab 610b is highlighted because the customer selected it.

In this illustration, the customer clicked the like icon a depicted on FIG. 7 causing the like icon a to be highlighted and the number of likes/dislikes to be increased from 132 on page 700 to 133 on the page 800 depicted on FIG. 8.

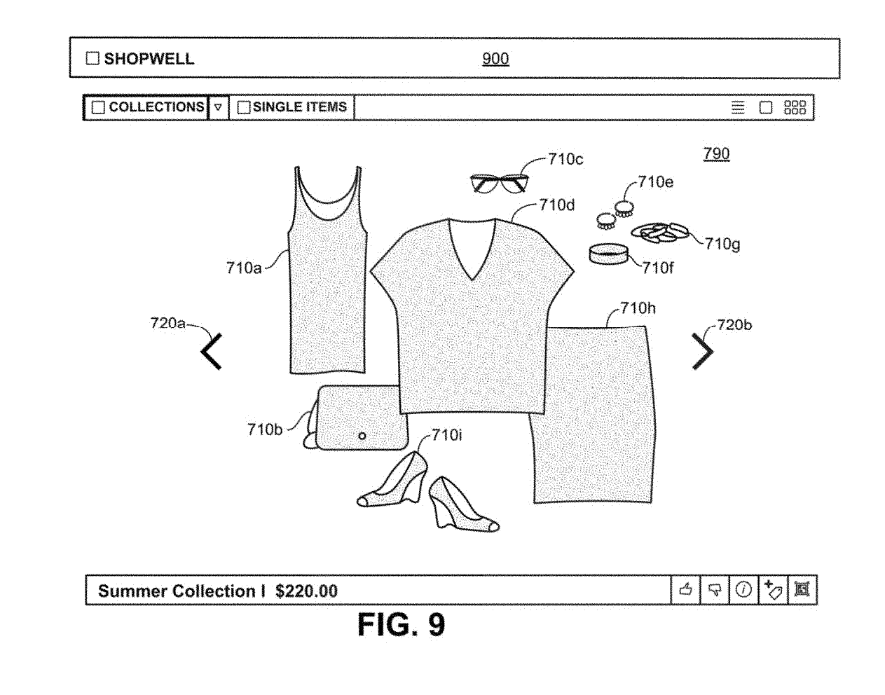

FIG. 9 depicts a page 900 with the highest ranked recommendation 790, according to one embodiment. The page 900 does not have tabs on the left side as depicted in FIG. 7.

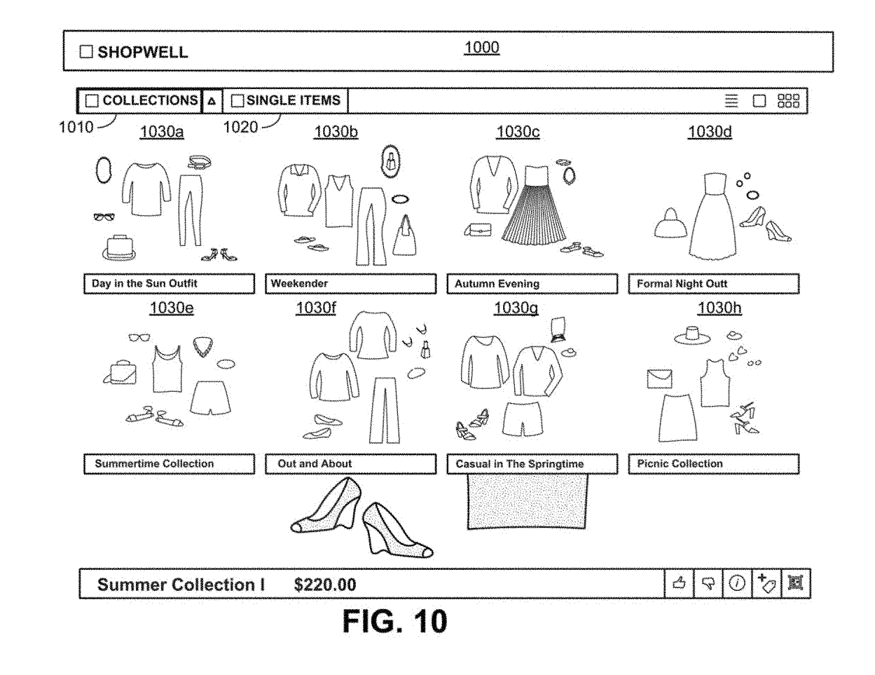

FIG. 10 depicts a page 1000 with more recommendations of collections for the customer, according to one embodiment. FIG. 10 depicts two options 1010 and 1020. One for displaying collections 1010 and the other for displaying single items 1020. The collections option 1010 is highlighted because the customer selected it.

The recommendations of collections form a recommendation hierarchy of recommendations that were dynamically generated based on the input that pertains to the customer where each recommendation provides a collection of coordinated items that provides a personalized ensemble. The recommendations in the hierarchy are ranked based on potential appeal to the customer. For example, a recommendation 790 that potentially has the highest appeal to the customer was already displayed to the customer on FIG. 7. The lower ranked recommendations are displayed on FIG. 10 and are ordered according to their rank from second highest to the lowest, for example starting at the upper left corner and proceeding to the lower right corner. More specifically, as depicted in FIG. 10, the recommendations are ranked from second highest to the lowest 1030a-1030h.

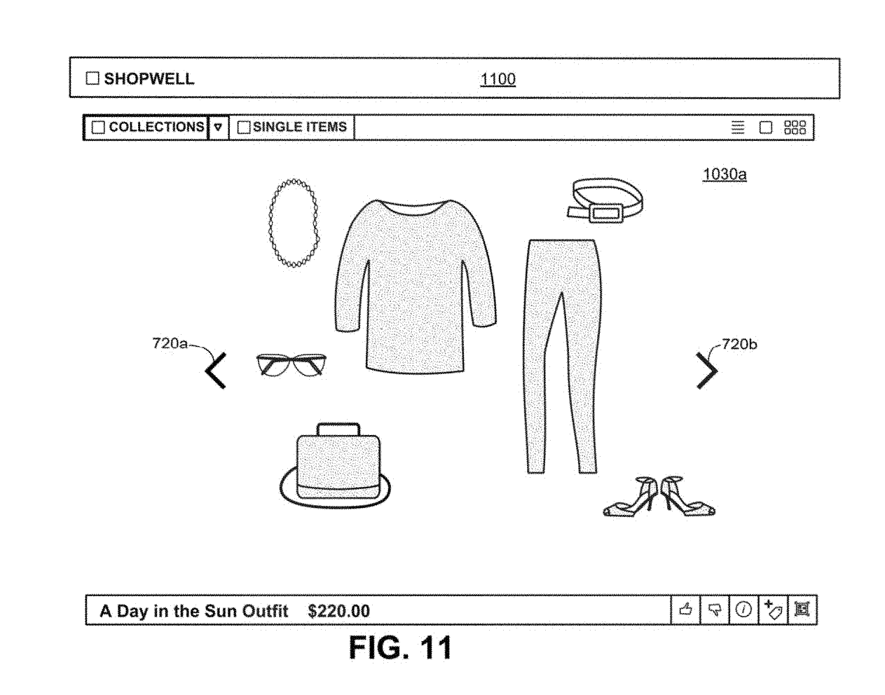

FIG. 11 depicts a page 1100 displaying the second ranked recommendation 1030a, according to one embodiment.

There is a left arrow 720a and a right arrow 720b associated with pages displaying recommendations for moving up or down the recommendation hierarchy, according to one embodiment. For example, if the customer clicks on the left arrow 720a, the user interface would display the highest ranked recommendation 790 as depicted on FIG. 7. If the customer clicks the right arrow 720b, the user interface would display the third ranked recommendation 1030b (FIG. 10).

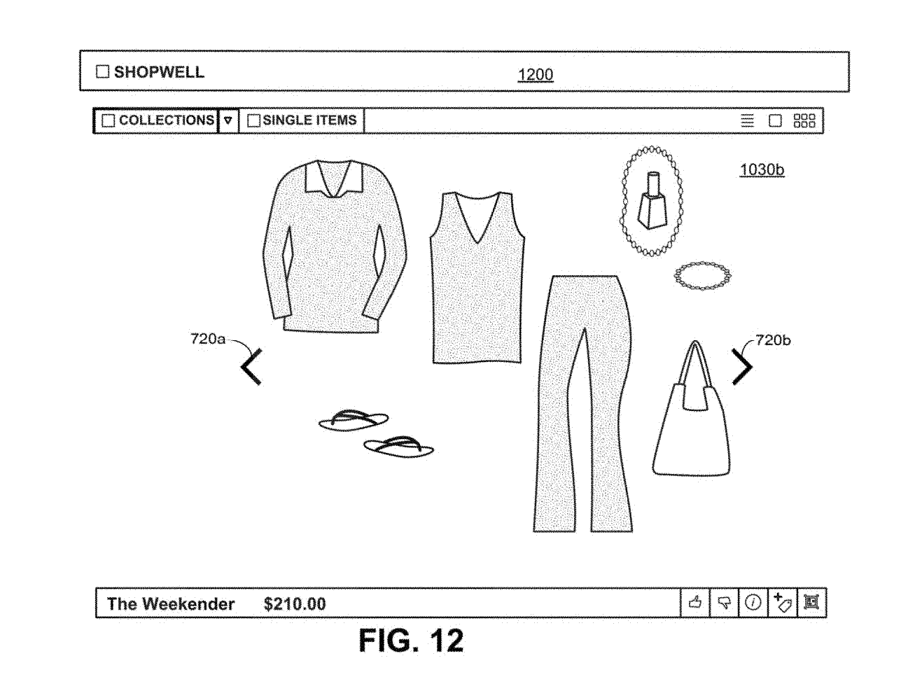

Assume in this illustration, that the customer clicks on the right arrow 720b displayed on the page 1100 because, for example, they did not find an item of interest in the second ranked recommendation 1030a. In response, FIG. 12 can be displayed, according to one embodiment.

FIG. 12 depicts a page 1200 displaying the third ranked recommendation 1030b, according to one embodiment.

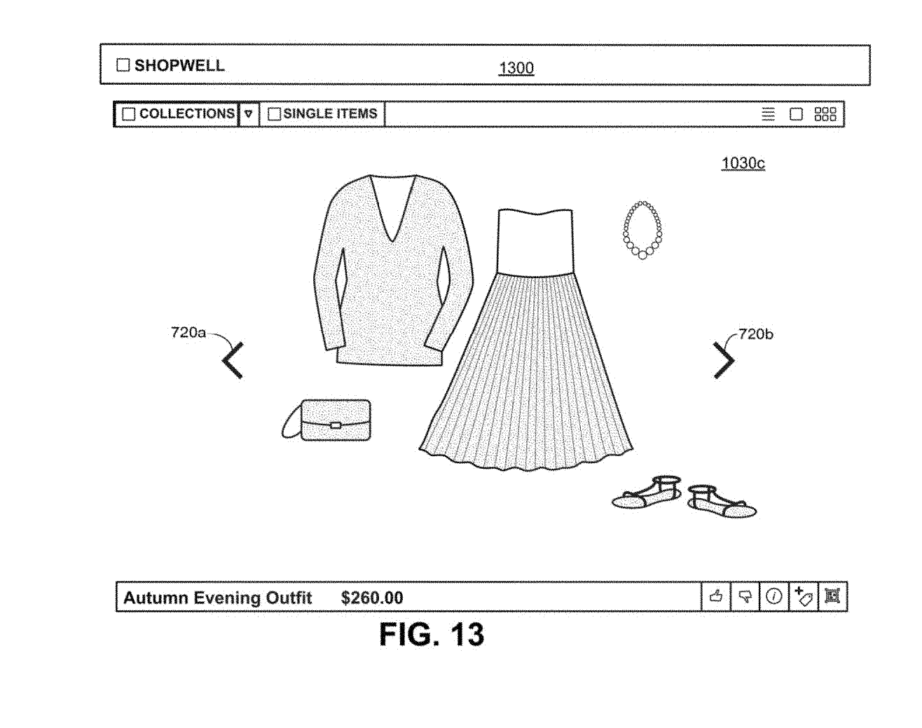

Assume in this illustration, that the customer clicks on the right arrow 720b displayed on the page 1200 because, for example, they did not find an item of interest in the third ranked recommendation 1030b. In response, FIG. 13 can be displayed, according to one embodiment.

FIG. 13 depicts a page 1300 displaying the fourth ranked recommendation 1030c, according to one embodiment.

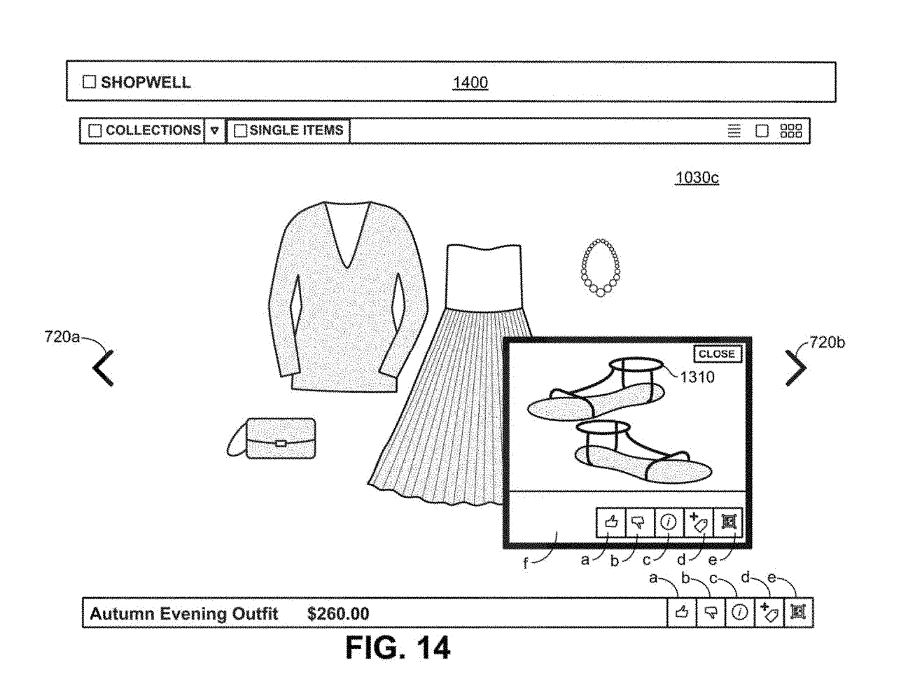

Assume in this illustration, that the customer clicked on the pair of shoes 1310 displayed on the page 1300 because they liked the shoes 1310 or they want more information about the shoes 1310. In response, FIG. 14 can be displayed. FIG. 14 depicts a page 1400 with a pop up window 1490 with an expanded view of the shoes 1310 that the customer selected in FIG. 13. The pop up window 1490 can display the price f of the shoes 1310 and various icons a-e.

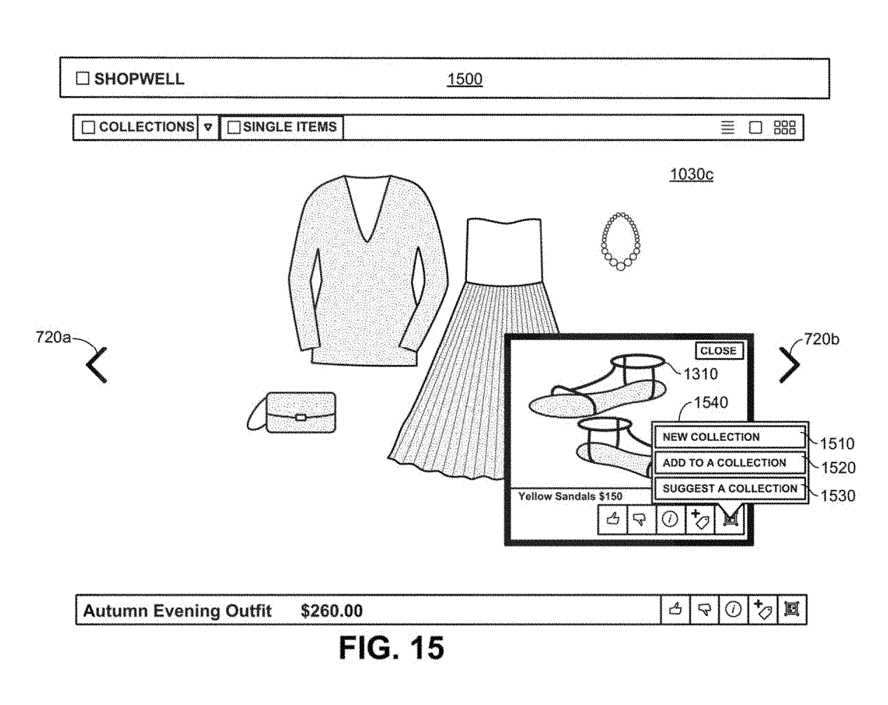

Assume in this illustration, that the customer clicked on the collection icon e in the pop up window 1490. In response, a menu 1540 can be displayed with options for new collection 1510, add to collection 1520 and suggest a collection 1530 as depicted in FIG. 15. According to one embodiment, the new collection option 1510 is for creating a new collection that includes the shoes 1310, the add to a collection option 1520 for adding these shoes 1310 to an existing collection, and the suggest a collection option 1530 for suggesting a collection with these shoes 1310. These are just a few example of options.

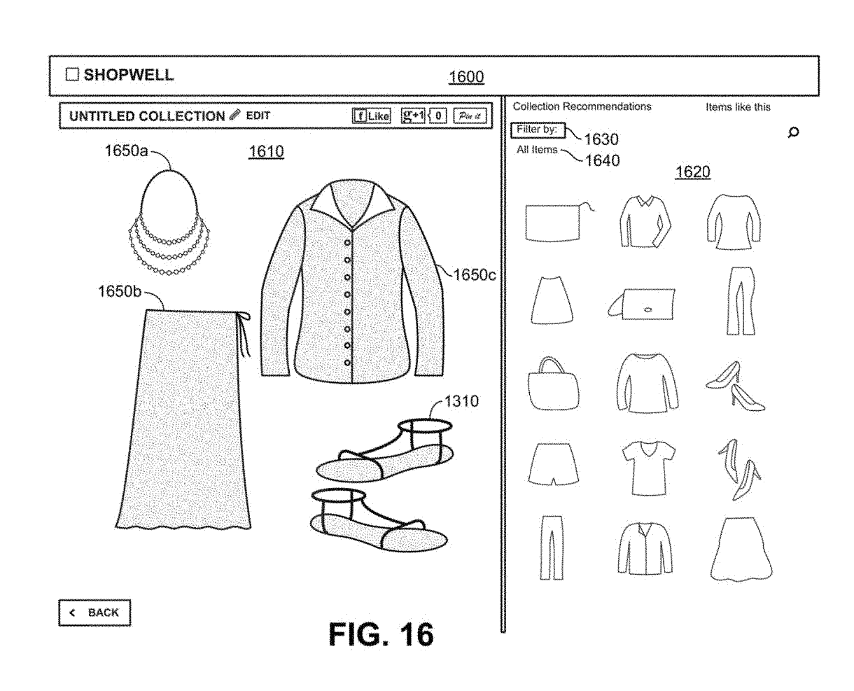

Assume in this illustration, that the customer selected the suggest a collection option 1530. In response, FIG. 16 can be displayed, according to one embodiment. FIG. 16 depicts a page 1600 with a suggested collection that includes the shoes 1310 the customer showed an interest in. In this illustration, the suggested collection includes the yellow shoes 1310, a pale blue long sleeved button down shirt 1650c, a dark blue calf length draw string loose fitting skirt 1650b, and a necklacee 1650a with four strands of beads that vary in color from dark blue to light blue to coordinate with the light blue shirt 1650c and the dark blue skirt 1650b. Various embodiments are well suited for suggested recommendations that include other items. The suggested collection is depicted on a first portion 1610 of the page 1600. Additional suggestions of items that the customer may be interested in viewing in combination with the yellow shoes 1310 are depicted on a second portion 1620 of the page 1600. As depicted, the first portion 1610 is on one side of the page 1600 and the second portion 1620 is on the other side of the page 1600. Various embodiments are well suited for other arrangements of components on the page 1600.

According to one embodiment, the page 1600 provides a drop down menu 1630 that allows the customer to choose a filter that determines the categories of items displayed in the second portion 1620. As depicted, the selected filter is for all items 1640. Therefore, the second portion 1620 of the page 1600 displays items that various categories, such as price, color, shirts, pants, dresses, shoes, handbags, coats, ties, jackets, sweaters, and accessories.

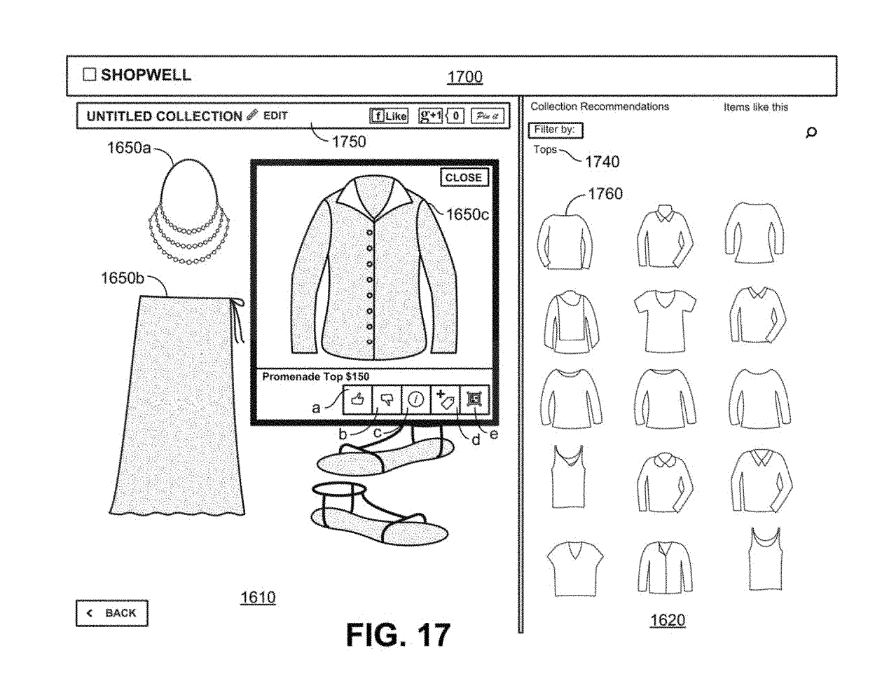

Assume in this illustration, that the customer clicked on the shirt 1650c because they want to select a different shirt for the collection. In response, FIG. 17 can be displayed.

FIG. 17 depicts a page 1700 with a pop up window 1750 with an expanded view of the shirt 1650c that the customer selected in FIG. 16. The page 1700 has a first portion 1610 and a second portion 1620. The first portion 1610 depicts the collection with the pop up window 1750 overlaying on top of the collection. The pop up window 1750 can display the price f of the shirt 1650c and various icons a-e. The customer has chosen to filter on tops 1740 and the second portion 1620 of the page on FIG. 17 displays various kinds of tops.

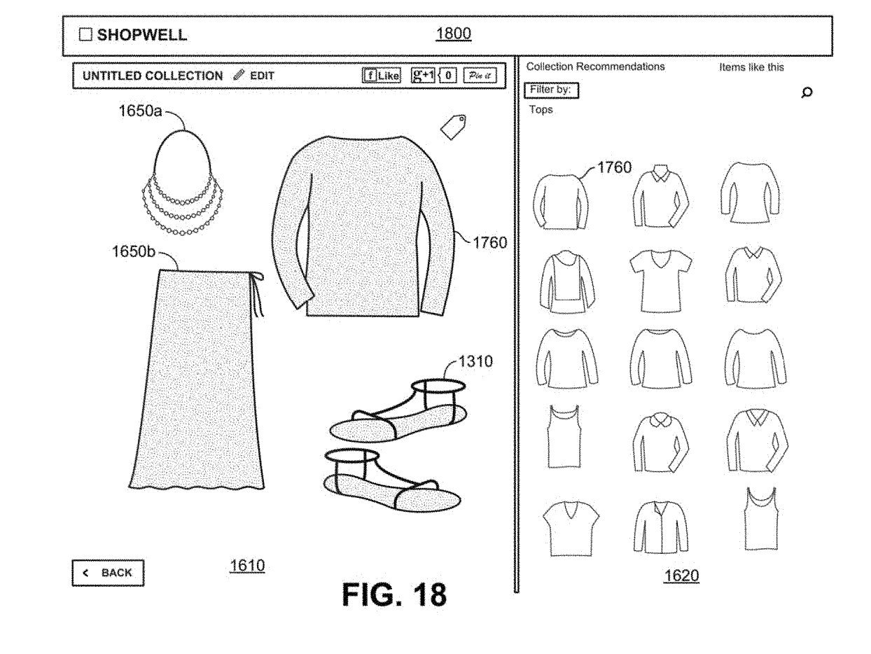

Assume in this illustration, that the customer then clicked on the sweater 1760 with the broad white and dark blue horizontal stripes that is displayed as a part of the second portion 1620 of the page 1700. In response, FIG. 18 can be displayed.

FIG. 18 depicts a page 1800 with a collection depicted in the first portion 1610 now includes the sweater 1760 with the broad white and dark blue horizontal stripes. The page 1800 has a first portion 1610 and a second portion 1620. The first portion 1610 depicts the collection. The collection depicted in the first portion 1610 includes the sweater 1760, the necklace 1650a, the skirt 1650b, and the shoes 1310. The second portion 1620 of the page depicted in FIG. 18 depicts various types of tops because the filter for the page still specifies tops.

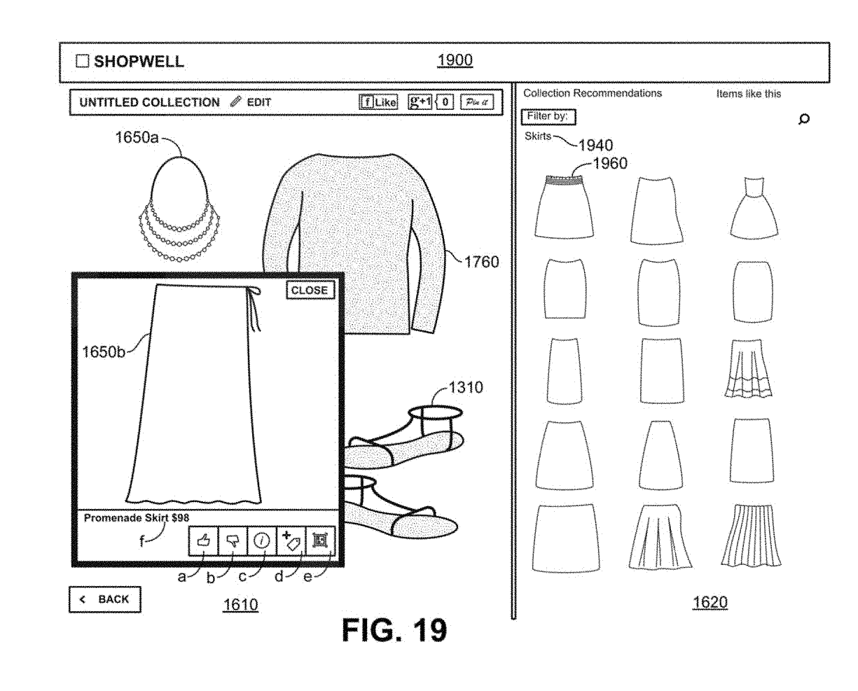

Assume in this illustration, the customer then clicks on the skirt 1650b because they want to select a different skirt for the collection. In response, FIG. 19 can be displayed.

FIG. 19 depicts a page 1900 with a pop up window 1950 with an expanded view of the skirt 1650b that the customer selected in FIG. 18. The page 1900 has a first portion 1610 and a second portion 1620. The first portion 1610 depicts the collection with the pop up window 1950 overlaying on top of the collection. The collection includes the necklace 1650a, the sweater 1760, the shoes 1310 and the skirt 1650b. The pop up window 1950 can display the price f of the skirt 1650b and various icons a-e. The customer has chosen to filter on skirts 1940 and the second portion 1620 of the page on FIG. 19 displays various kinds of skirts.

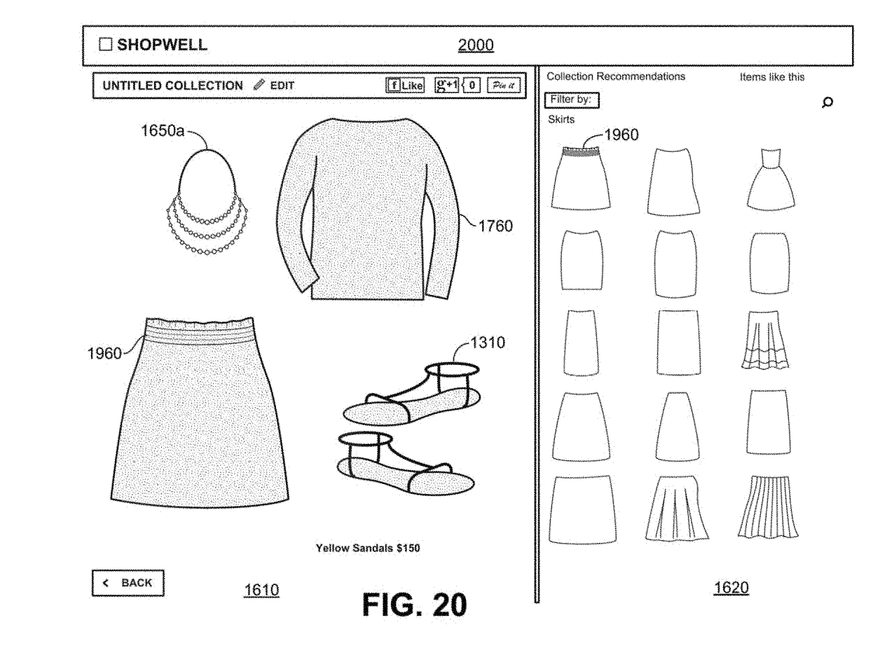

Assume in this illustration, that the customer then clicked on the knee length blue gathered skirt 1960 that can be displayed as a part of the additional suggests in the second portion 1620 of the page 1900. In response, FIG. 20 can be displayed.

FIG. 20 depicts a page 2000 with a collection that now includes the knee length blue gathered skirt 1960. The page has a first portion 1610 and a second portion 1620. The first portion 1610 depicts the collection. The customer has chosen to filter on skirts and the second portion 1620 of the page on FIG. 20 displays various kinds of skirts.

At this point, according to one embodiment, the collection displayed in the first portion 1610 of the page 2000 depicted on FIG. 20 includes the yellow shoes 1310 selected on FIG. 13, the necklace 1650a that is a part of the suggested collection depicted on FIG. 16, the sweater 1760 with the broad white and dark blue horizontal stripes that was selected as depicted on FIG. 17, and the knee length blue gathered skirt 1960 that was selected as depicted on FIG. 19.

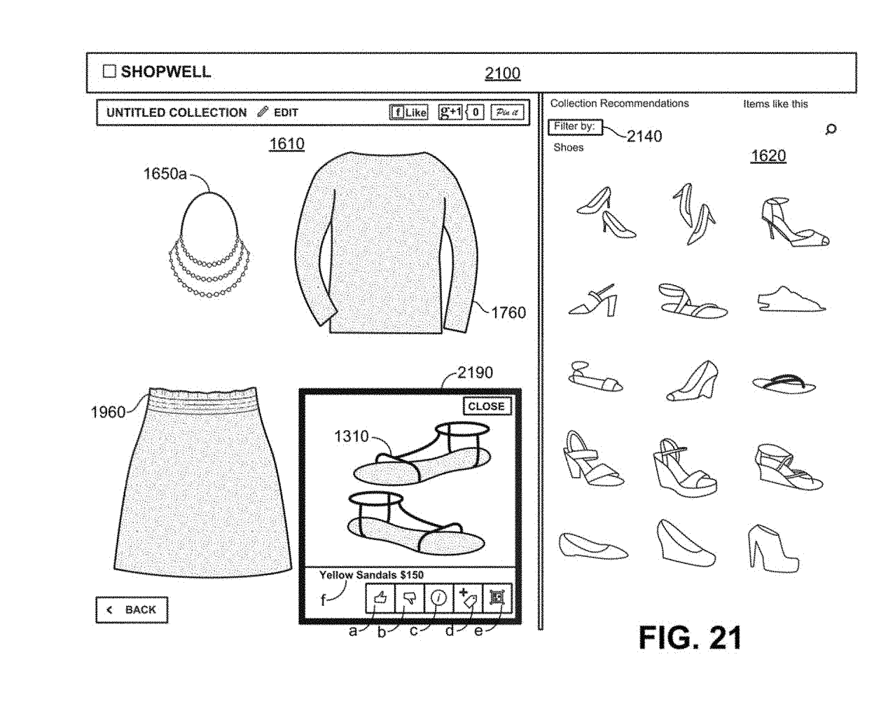

Assume in this illustration, that the customer then clicks on yellow shoes 1310 because, for example, they want to select a different pair of shoes for the collection. In response, FIG. 21 can be displayed.

FIG. 21 depicts a page 2100 with a pop up window 2190 with an expanded view of the yellow shoes 1310 that the customer selected on FIG. 20. The page 2100 has a first portion 1610 and a second portion 1620. The first portion 1610 depicts the collection with the pop up window 2190 overlaying on top of the collection. The collection as depicted includes the necklace 1650a, the skirt 1960, the sweater 1760 and the shoes 1310. The pop up window 2190 can display the price f of the shoes 1310 and various icons a-e. The customer has chosen to filter on shoes 2140 and the second portion 1620 of the page 2100 on FIG. 21 displays various kinds of shoes.

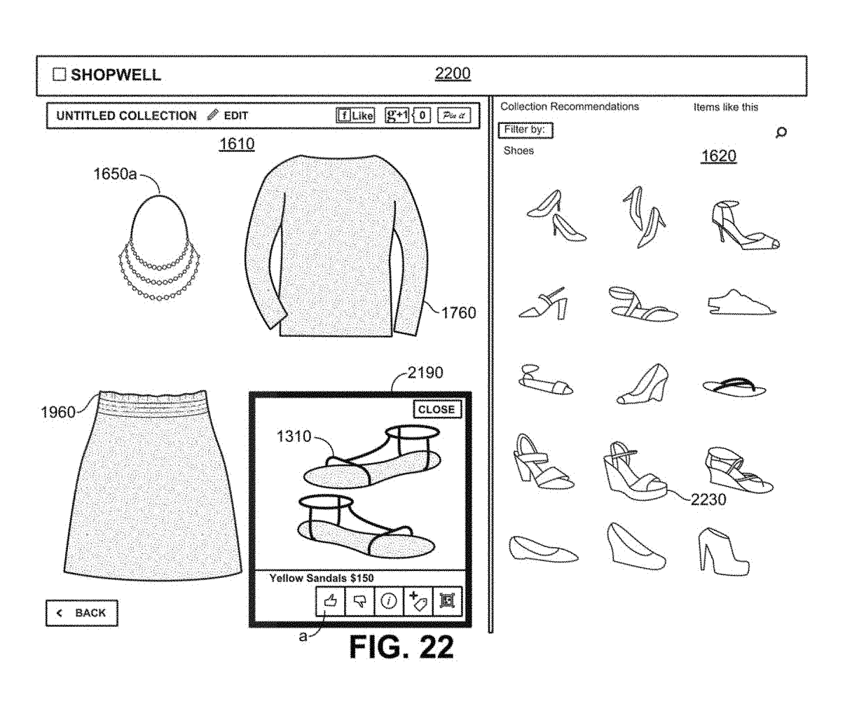

The pop up window 2190 has various icons a-e. The customer clicks the like icon a indicating that they like the yellow shoes 1310. In response, FIG. 22 can be displayed.

FIG. 22 depicts a page 2200 that is similar to FIG. 21 except that the like icon a of the pop up window 2190 is highlighted due to the customer clicking the like icon a on the previous page depicted in FIG. 21.

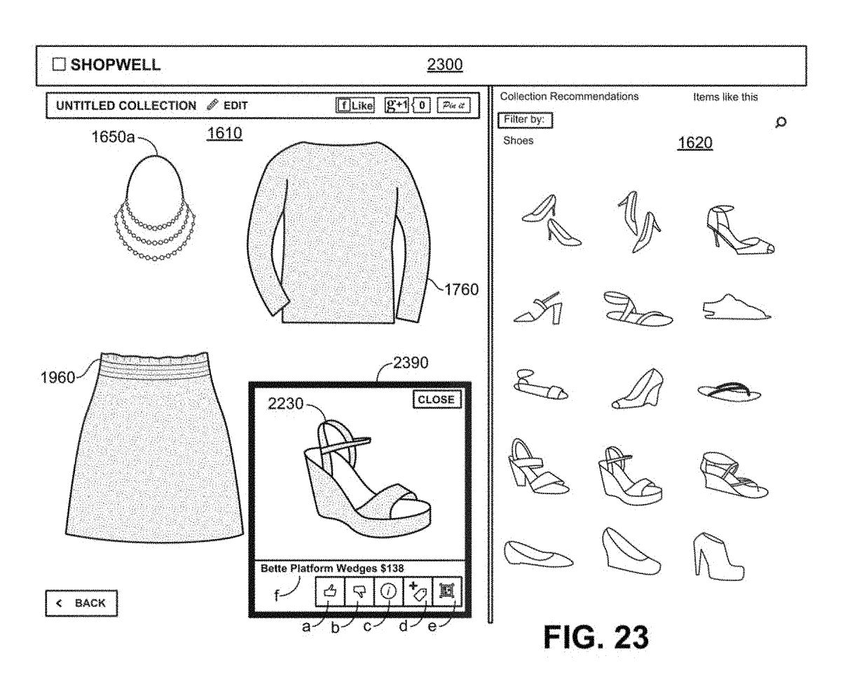

Assume that the customer selects the brown high platform shoes 2230 with the ankle straps depicted in the second portion 1620 of FIG. 22. In response, FIG. 23 can be displayed.

FIG. 23 depicts a page 2300 with a pop up window 2390 with an expanded view of the brown high platform shoes 2230 with the ankle straps. The page 2300 has a first portion 1610 and a second portion 1620. The first portion 1610 depicts the collection with the pop up window 2390 overlaying on top of the collection. The collection as depicted in the first portion 1610 of the FIG. 23 includes the necklace 1650a, the sweater 1760, the skirt 1960 and the shoes 2230. The pop up window 2390 can display the price f of the brown high platform brown ankle strapped shoes 2230 and various icons a-e. The customer has chosen to filter on shoes and the second portion 1620 of the page on FIG. 23 displays various kinds of shoes.

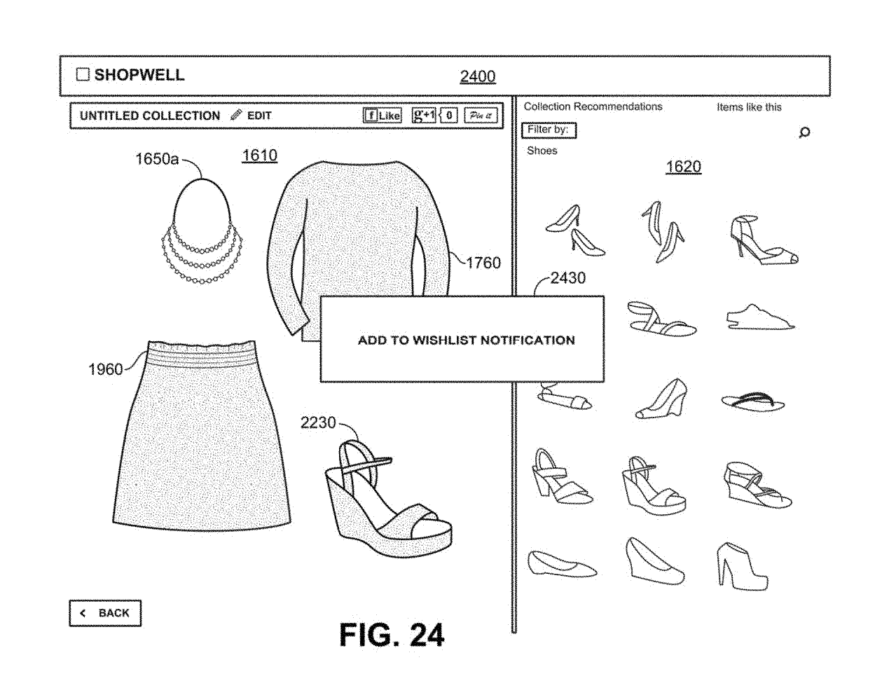

Assume that the customer clicks on the wish list icon d displayed in the pop up window 2390. As a result, the page depicted on FIG. 24 can be displayed.

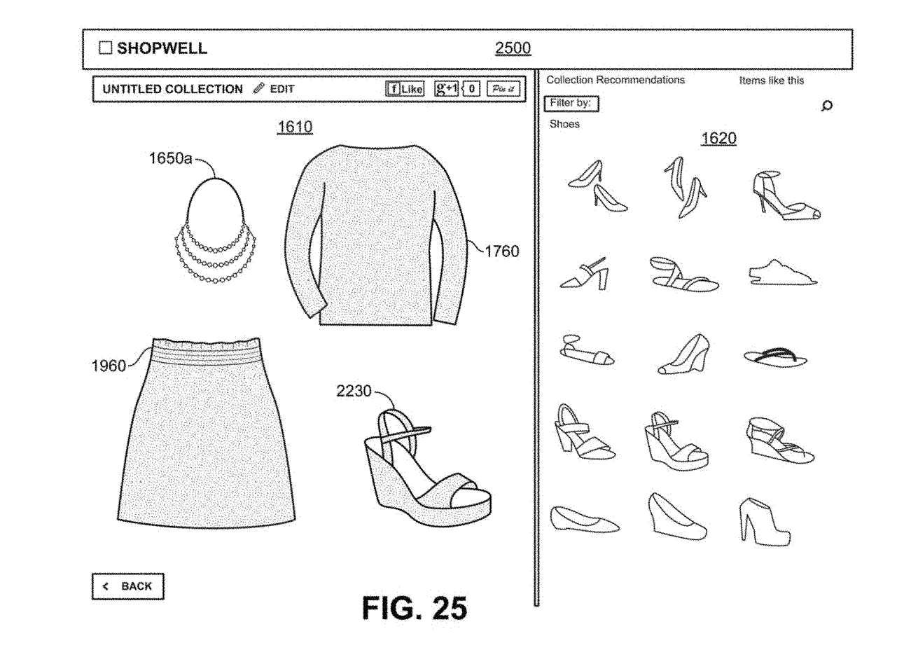

FIG. 24 depicts a page 2400 with a collection that includes the brown high platform brown ankle strapped shoes 2230 and text 2430 indicating that the selected shoes 2230 were added to the customer's wish list. The text is eventually removed resulting in FIG. 25.

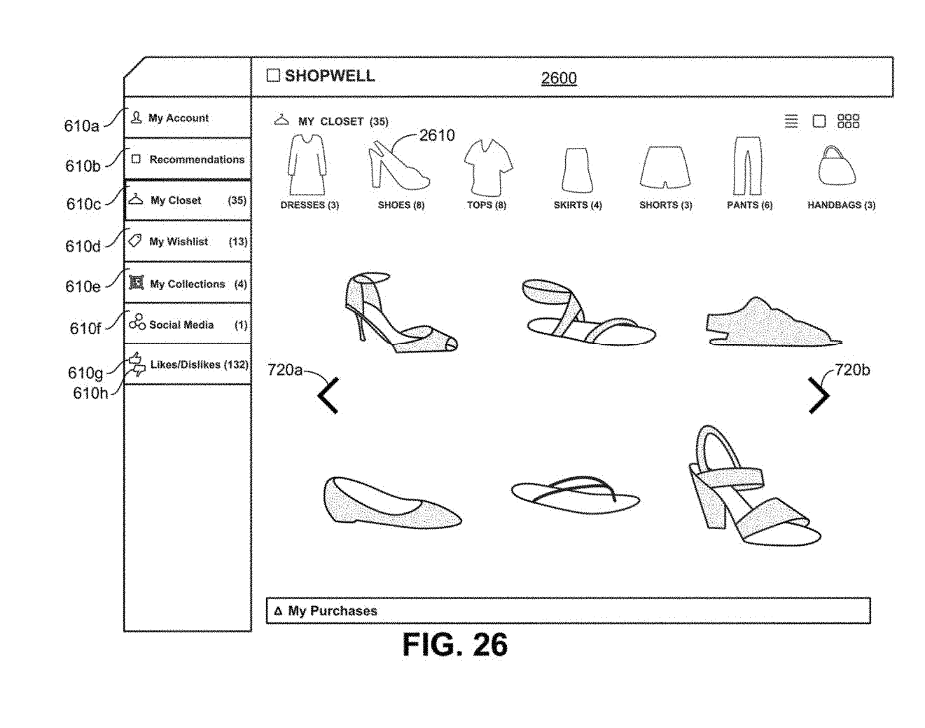

Assume that the customer selects the my closet tab 610c and then selects the shoes 2610 in their closet. As a result, the page depicted FIG. 26 can be displayed.

FIG. 26 depicts a page 2600 with the shoes that are in the customer's closet. The page 2600 depicted on FIG. 26 displays various tabs 610a-610h on the left side. The my closet tab 610c is highlighted because the customer selected it.

According to one embodiment, the customer's closet includes the items of apparel that they have purchased, for example, from one or more retailers that use the collection recommendation system. At the top of the page are icons that represent various types of items in their closet such as the dresses, the shoes, the tops, the skirts, the shorts, the pants and the handbags. The page 2600 indicates that there is a total of 35 items in their closet with 3 dresses, 8 shoes, 8 tops, 4 skirts, 3 shorts, 6 pants, and 3 handbags. Since the customer is interested in the shoes in their closet, the shoe icon 2610 at the top is highlighted. A subset of all of the items in a category can be displayed. For example, the page 2600 depicts 6 of the 8 shoes that are in their closet.

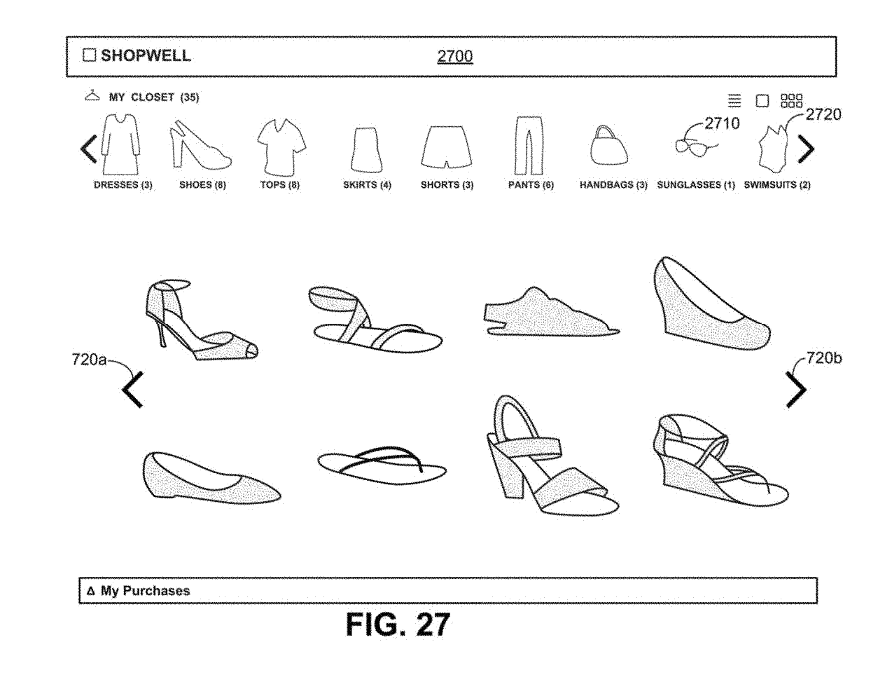

FIG. 27 depicts a page 2700 that displays all of the shoes in the customer's closet, according to one embodiment. FIG. 27 also depicts additional icons 2710, 2720 that represent additional categories of items such as sunglasses and swimsuits. This customer has one pair of sunglasses and two swimsuits in their closet.

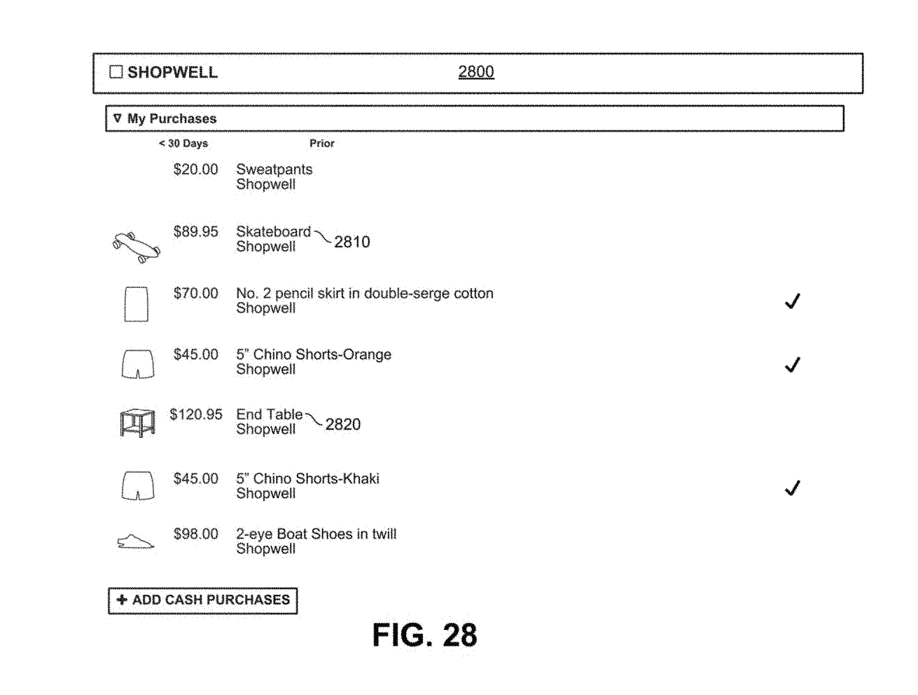

There may be other categories of items besides apparel that the customer has purchased. FIG. 28 depicts a page 2800 with other categories of items that the customer has purchased such as a skateboard 2810 and an end table 2820. Boxes that can be checked are associated with each of the purchased items, according to one embodiment. The boxes associated with the purchased apparel items, according to one embodiment, are checked.

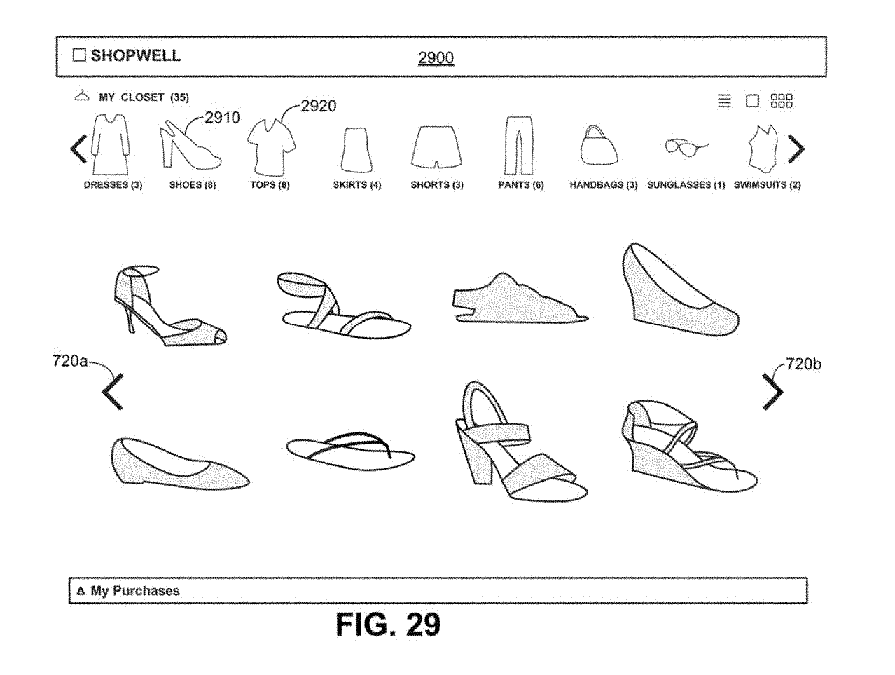

Assume that the customer wants to return to viewing items that are in their closet. As a result, FIG. 29 can be displayed. FIG. 29 depicts a page 2900 that displays the shoes that are in the customer's closet, according to one embodiment. The shoe icon 2910 at the top of the page 2900 is highlighted since, according to one embodiment, this page 2900 is depicting the shoes in the customer's closet.

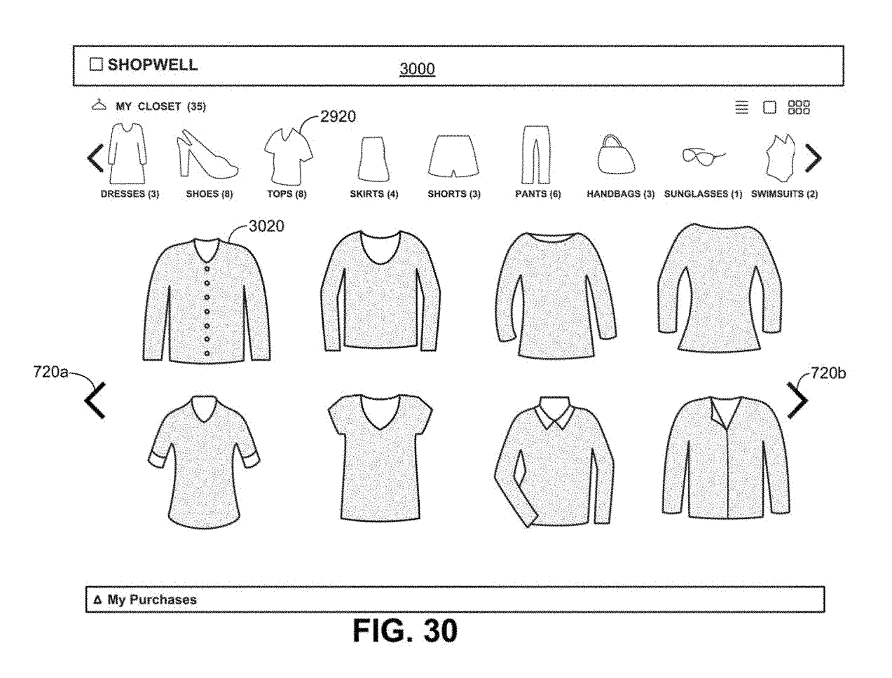

Assume that the customer selects the top icon 2920 because they are interested in viewing the tops that are in their closet. As a result, the page as depicted on FIG. 30 can be displayed.

FIG. 30 depicts a page 3000 with the tops that are in the customer's closet, according to one embodiment. The top icon 2920 is highlighted. As depicted, the eight tops in the closet are also displayed on the page 3000.

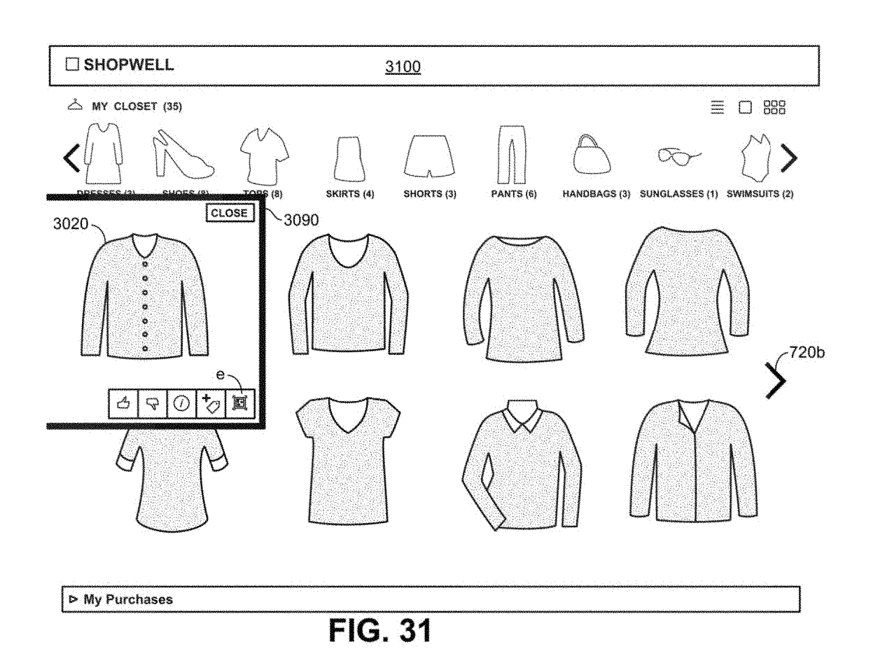

Assume that the customer selects the green sweater 3020 in the top left corner. As a result, a page as depicted on FIG. 31 can be displayed.

FIG. 31 depicts a page 3100 with a pop up window 3090 with an expanded view of the green sweater 3020, according to one embodiment.

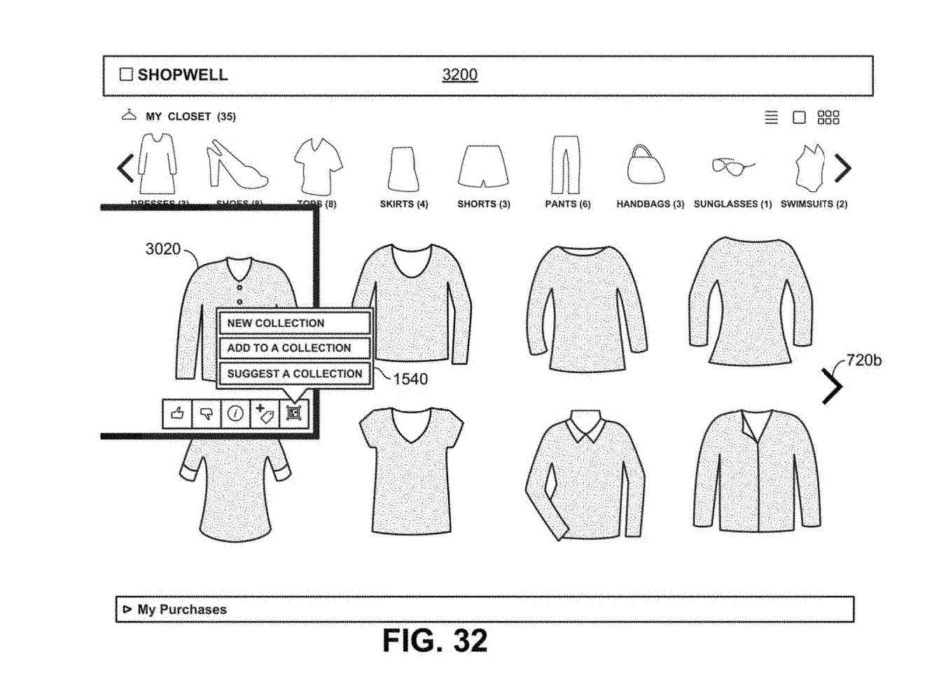

Assume that the customer selects the collection icon e on the pop up window 3090 depicted in FIG. 31. In response, a menu 1540 can be displayed with options for new collection 1510, add to collection 1520 and suggest a collection 1530 as depicted on the page 3200 of FIG. 32.

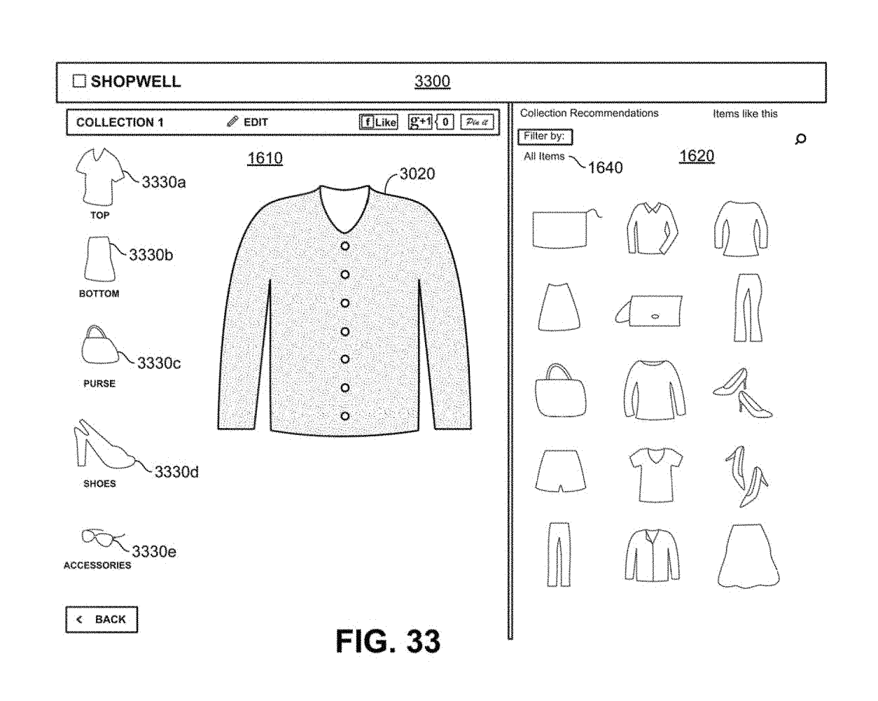

Assume in this illustration, that the customer selected the new collection option 1510. In response, FIG. 33 can be displayed, according to one embodiment.

FIG. 33 depicts a page 3300 with a new collection that includes the green sweater 3020 that the customer selected on the page 3100 depicted in FIG. 31.

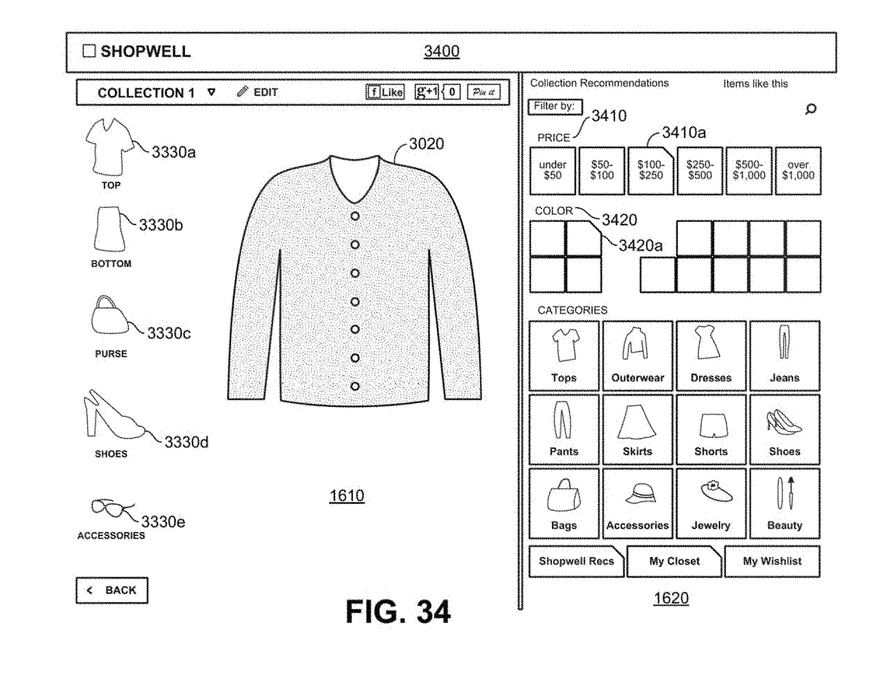

The page 3300 has a first portion 1610 and a second portion 1620. The first portion 1610 depicts the green sweater 3020 and icons 3330a-3330e that represent categories of items (also referred to herein as “item category icons”) for a collection, such as a top 3330a, bottom 3330b, purse 3330c, a pair of shoes 3330d, and an accessory 3330e. The top icon 3330a is checked because the new collection includes the green sweater 3020. The bottom icon 3330b, the purse icon 3330c, the shoe icon 3330d, and the accessories icon 3330e are not checked because items for these categories 3330b-3330e have not yet been added to the new collection. The customer has chosen to filter on all items 1640 and the second portion 1620 of the page on FIG. 17 displays all items. Assume that the customer decides to filter on price and color. In response, a page 3400 as depicted in FIG. 34 can be displayed.

According to one embodiment, different types of collections can include items for different categories. For example, one type of collection may include items for the categories dress, shoes, purse, jewelry, purse. Another type of collection may include items for the categories pants, shoes, scarf, jewelry, and purse. Yet another type of collection may include items for the categories pants, shirt, jacket and tie. According to one embodiment, icons that represent the categories associated with the respective type of collection to facilitate associating items with the collection for the appropriate categories. According to one embodiment, the collection recommendation system automatically determines categories to associate with a type collection. For example, the collection recommendation system may use the specified preferences to determine categories to associate with a type collection. According to one embodiment, a user of the collection recommendation system can determine what categories to associate with a type collection. In another example, the collection recommendation system may initially suggest the categories to associate with a type collection and a user can modify the categories associated with a type of collection. The collection recommendation system can dynamically generate a personalized ensemble using the categories associated with a type of collection. For example, if that type of collection has categories of dress, shoes, purse, jewelry and a scarf, the collection recommendation system can use various inputs to dynamically generate items for dress, shoes, purse, jewelry and a scarf for that type of collection and rank the dynamically generated collection recommendation as discussed herein.

FIG. 34 depicts the green sweater 3020, the item category icons 3330a-3330e, a plurality of price ranges 3410, colors 3420, and various items that may be organized according to category 3330a-3330e. The page 3330 has a first portion 1610 and a second portion 1620. The green sweater 3020 and the item category icons 3330a-3330e are displayed in the first portion 1610. According to one embodiment, the first portion 1610 is to one side of the page 3400 and the second portion 1620 is on the other side of the page 3400. The plurality of price ranges, colors, and various items that satisfy the one or more filters 3410, 3420 are displayed in the second portion 1620. Various embodiments are well suited to using different organizations for displaying the portions 1610, 1620 and the various components on the page 3400.

The range of prices 3410 in this illustration include under $50,$50-$100, $100-$250, $500-$1000, over $1000. The colors 3420 include or complement, or a combination thereof, the colors included in the customer's specified preferred colors 630a depicted on FIG. 6. As depicted on FIG. 34, the customer selected the $100-$250 range and hunter green. According to one embodiment, the selections are indicated by annotating a corner of the block that the customer selected. For example, the block 3410a that represents the $100-$250 range and the block 3420a that represents hunter green are both annotated in this example. The various items that are depicted in the second portion 1620, according to one embodiment, are grouped according to categories. For example, items, such as tops and outerwear, that would be worn on the upper body are grouped, items, such as dresses, that would be worn on the upper body and at least part of the lower body, are grouped, items worn on the lower body, such as jeans, pants, skirts and shorts, are grouped, items worn on the feet, such as shoes, are grouped, the accessories, such as bags, hats, and jewelry are grouped. The customer can complete the collection with the green sweater, for example, by selecting items for each of the categories displayed in the second portion 1620.

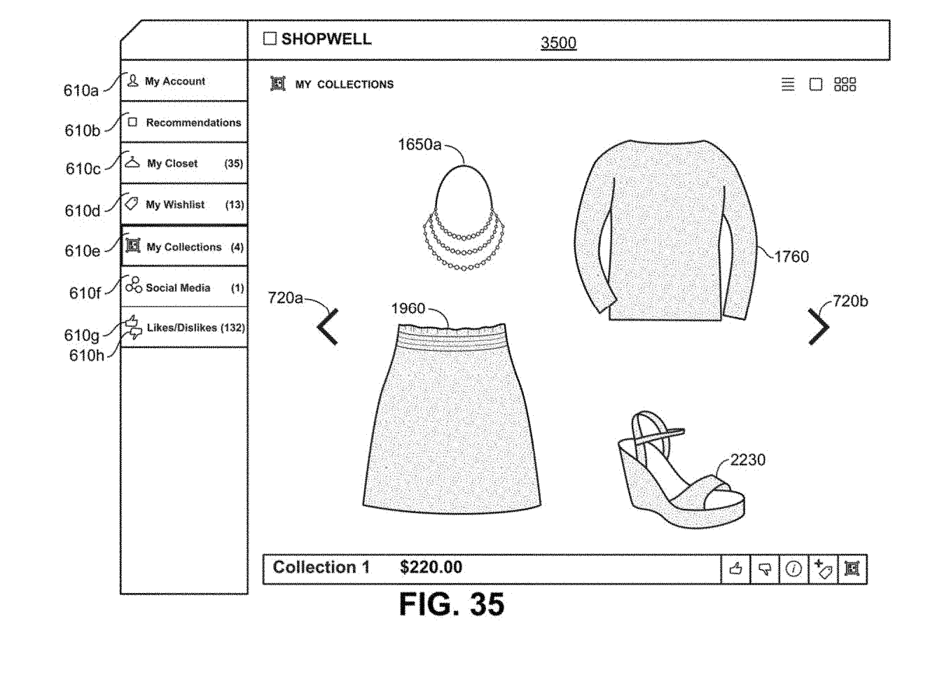

FIG. 35 depicts a page 3500 with a collection recommendation displayed as a result of the customer selecting the collections tab 610e, according to one embodiment. The page 3500 depicted on FIG. 35 displays various tabs 610a-610h on the left side, as described herein. As depicted, the my collections tab 610e is highlighted because the customer selected it and there are four collections for this customer. The customer can move through the four collections using the left and right arrows 720a, 720b on the pages that the collections are displayed on.

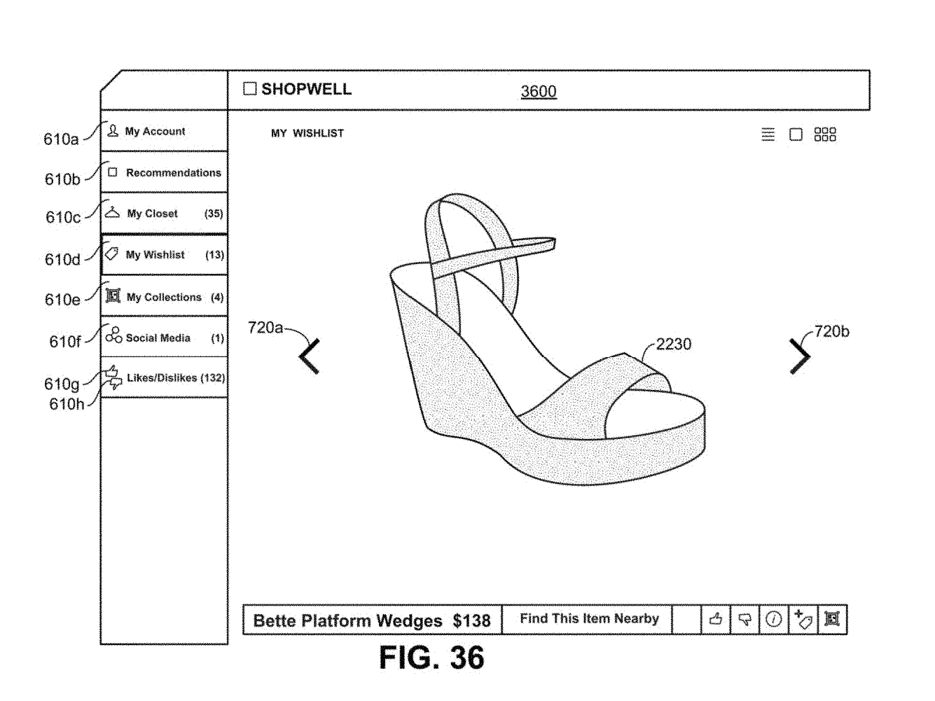

FIG. 36 depicts a page 3600 with a pair of shoes 2230 displayed as a result of the customer selecting the wishlist tab 610d, according to one embodiment. The page 3600 depicted on FIG. 36 displays various tabs 610a-610h on the left side, as discussed herein. As depicted, the wishlist tab 610d is highlighted because the customer selected it and there are 13 items in the customer's wish list. The customer can move through the 13 items in the wish list using the left and right arrows 720a-720b on the pages that the wish list items are displayed on. blah

According to one embodiment, the items associated with a displayed recommendation are available. For example, items that have sold out or that are not available are not presented as a part of a collection recommendation, according to one embodiment.

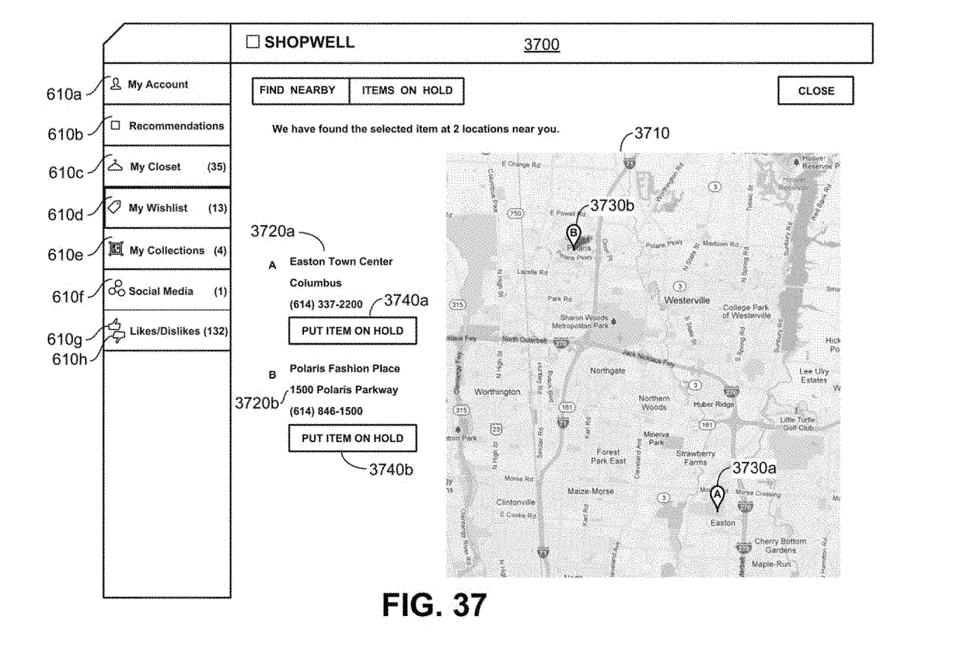

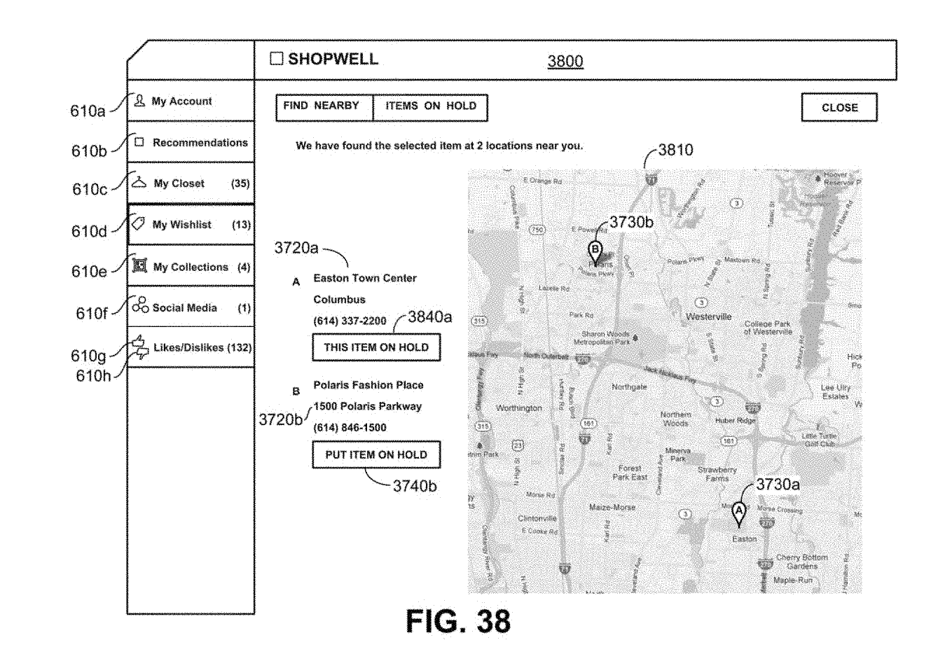

FIGS. 37 and 38 depict pages 3700, 3800 with maps 3710, 3810 that show the locations 3730a, 3730b of stores on the maps 3710, 3810 and provide contact information 3720a, 3720b of the stores for purchasing or holding an item, according to one embodiment. As depicted on FIG. 37, the text 3740a, 3740b indicates that the customer requested that one or more items be placed on hold at the respective stores associated with the contact information 3720a, 3720b. As depicted on FIG. 38, the text 3840a indicates that an item was successfully placed on hold for the store associated with the contact information 3720a.

The pages 3700, 3800 depicted on FIGS. 37 and 38 display various tabs 610a-610h on the left side, as discussed herein. The my wishlist tab 610d is highlighted on the pages 3700, 3800 because the customer selected it.

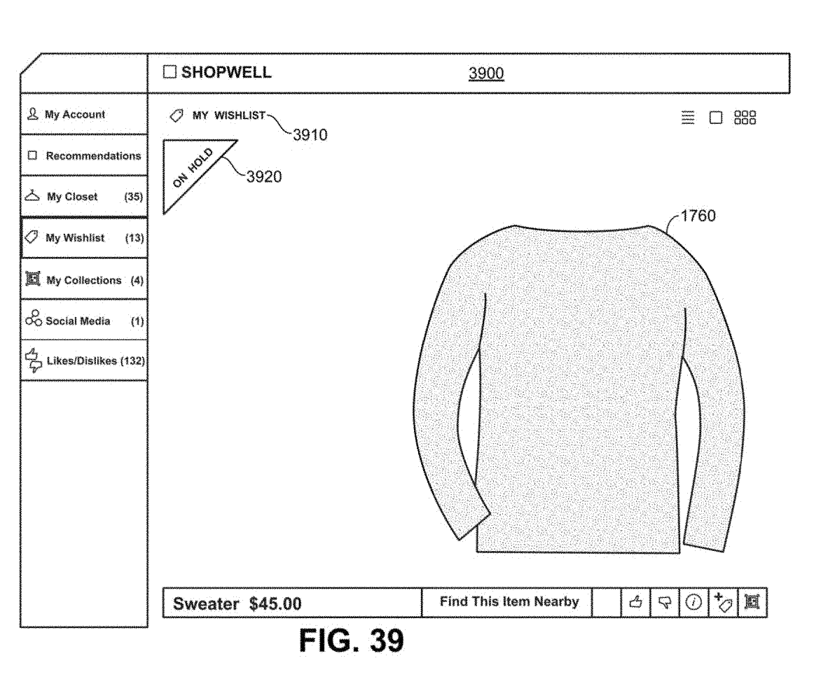

A customer may have placed an item in their wish list and then wanted to purchase that item or put it on hold. A map 3710, 3810, as depicted on FIGS. 37 and 39, can be used to find one or more stores where the item can be purchased or put on hold. The location 3730a, 3730b of the one or more stores may be indicated on the map 3710, 3810.

Various embodiments provide service to a customer from the moment that they express an interest and start using the collection recommendation system to the moment that an ordered item is delivered to the customer either at the door of their residence or at one of the retailer's stores. For example, the customer can enter the collection recommendation system and start using it to dynamically generate recommendations. They can use the collection recommendation system to purchase an item from a retailer selected, for example, using pages 3700, 3800 displayed on FIGS. 37 and 39. The retailer can then deliver the purchased item to the customer's door or the customer can come to one of the retailer's locations obtained using a map 3700, 3800 as depicted on FIGS. 37 and 38.

FIG. 39 depicts a page 3900 that displays a sweater 1760 in the customer's wish list 3910 and displays text 3920 indicating that the sweater 1760 has been placed on hold, according to one embodiment. Various embodiments are also well suited for a page that displays an item that has been purchased and text indicating that the item has been purchased.

Various pages provide a mechanism for the customer to associate a title with the displayed collection. For example, the customer can enter or amend a title of a collection as depicted at least in FIGS. 16-25, 33 and 34.

According to one embodiment, a collection recommendation system is provided by a business (also referred to herein as a “system providing business”) that has access to information for a multitude of retailers. Examples of retailers in the apparel industry are J. Crew, Talbot, and Macy's. According to one embodiment, the business is a credit card financing business that provides private labeled credit cards with different retailer labels for each of the retailers. For example, the business can provide a Macy's credit card for Macy's, a Talbot credit card for Talbot and a J. Crew credit card for J. Crew. The business obtains information about customers when they apply for the private labeled credit cards, such as one or more of their names, their email addresses, their ages, their incomes, where they live, how many children they own, their types of employment, the names of their businesses, among other things.

According to various embodiments, the collection recommendation system is provided for enhancing a retailer's revenue. There are various ways that the system providing business can in turn increase their revenues. The system providing business can increase their revenues by charging the retailers a fee for using or buying the collection recommendation system, according to one embodiment (also referred to as “fee based business model”).

According to another embodiment, the system providing business's revenues are automatically increased due to the increase in customer purchases being charged to the private labeled credit cards that they issue for the retailers (also referred to as “no fee business model”). For example, the customers will see the collections and be motivated to purchase and charge more items on the private labeled credit cards. It is estimated that the collection recommendation system will increase the average purchases charged on the private labeled credit cards from 1.8 items to 2.3 items per transaction. The charging of more purchases on the private labeled credit cards results in more revenue for the system providing business, which issues the private labeled credit cards. In this case, neither the retailer nor the customer may be charged a fee for the collection recommendation system.

According to another embodiment, a combination business model can be used that is a combination of the fee based business model and the no fee business model.

According to various embodiments, input that pertains to a customer can be received by the collection recommendation system. Examples of the input are inputs from the retailer, more general customer inputs, finer grained customer inputs pertaining to customers' preferences on individual items, empirical data, and information about other customers that are similar to a customer.

Examples of inputs from the retailer include management cards. Examples of management cards are the combinations of items that may appear in catalogs or that may be used to dress mannequins in stores (also referred to as “mannequin cards”).

Examples of the more general customer inputs include, among other things, their personal information, the individuals or groups the customer is interested in sharing information with, social media, and their more general preferences. Examples of personal information include their names, their size information, their birth date, and their anniversary. Their more general preferences include the colors and styles that they prefer. In various illustrations, a customer can indicate their color and style preferences on the my account page depicted on FIG. 6, according to one embodiment.

Examples of finer grained customer inputs include feedback from the customers as to individual items that they like and individual items that they dislike. For example, the customer may indicate that they like item A and that they dislike item B. The finer grained customer inputs may be binary like or dislike. The finer grained customer inputs may include a prioritization of their likes and dislikes of individual items. For example, the customer may indicate that they dislike both items A and B but that they dislike B more than A. Further, the customer may indicate that they like both items C and D and that they like item C more than item D. In various illustrations, a customer can indicate that they like or dislike something using the respective like icons or dislike icons.

Examples of empirical data include demographic information and purchase history about the customer. Examples of demographic information include name, email address, age, income, location of residence, number of children, type of employment, and name or type of business. Examples of purchase history include category of item purchased, price of the item purchased, date of purchase, location of purchase, and retailer the item was purchased from.

Information about other customers includes demographic information or purchase history, or a combination thereof, for other customers that are similar to that customer.

According to various embodiments, a system providing business may have relationships with, for example, hundreds of retailers, where each retailer may have one, two or more brands. The system providing business may also have relationships with several million households and over a hundred years of preference history providing a vast amount of input pertaining to a customer for the system providing business to utilize.

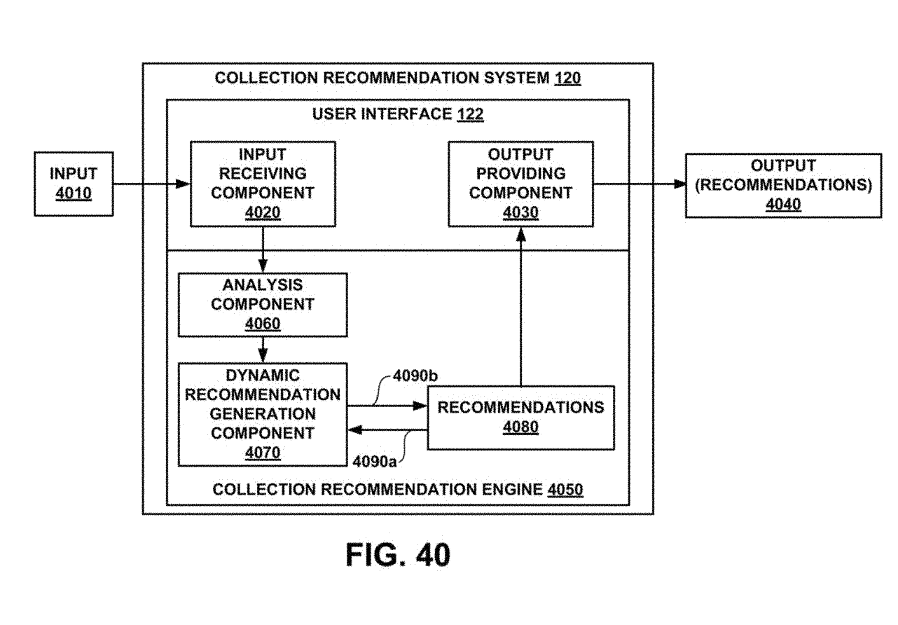

FIG. 40 depicts a block diagram of a collection recommendation system 120, according to one embodiment.

The blocks that represent features in FIG. 40 can be arranged differently than as illustrated, and can implement additional or fewer features than what are described herein. Further, the features represented by the blocks in FIG. 4000 can be combined in various ways. The system 4000 can be implemented using hardware, hardware and software, hardware and firmware, or a combination thereof

According to one embodiment, a collection recommendation system 120 is provided to the retailer 130 where the collection recommendation system 120 is for dynamically generating personalized recommendations 4040 for different customers of the retailer.

As depicted, the collection recommendation system 120 includes a user interface 122 and a collection recommendation engine 4050. The user interface 122 includes an input receiving component 4020 and an output providing component 4030. The collection recommendation system 120 includes an analysis component 4060 and a dynamic recommendation generation component 4070.

The input receiving component 4020 is for receiving input 4010 that pertains to a customer. The analysis component 4060 is for analyzing the input 4010 that pertains to the customer. The dynamic recommendation generation component 4070 is for dynamically generating, based on the input 4010, a recommendation 4040 for the customer that includes a collection of coordinated items that provides a personalized ensemble. The output providing component 4030 is for providing the recommendation 4040 as output. The output 4040 can be one or more recommendations. The output 4040 can be a hierarchy of recommendations, for example, as depicted on FIGS. 9 and 10. The one or more recommendations 4040 can be displayed on a computer screen or printed on paper, among other things.

According to one embodiment, the collection recommendation system 120 provides a personalized ensemble by, for example, providing two customers with different recommendations that respectively include different collections when they express an interest in the same item. The personalized ensembles for each of the customers are provided by selecting items for the collections based on each of the respective inputs that pertain to the customers. Therefore, even though both of the respective customers' collections include an item A, one or more of the other items in their respective collections are different, according to one embodiment. The inputs that pertain to the customers can include any one or more of inputs from the retailer, more general customer inputs, finer grained customer inputs pertaining to customers' preferences on individual items, empirical data, and information about other customers that are similar to a customer. For example, the respective inputs associated with the respective customers can result in dynamically generating an ensemble that is personalized for the first customer that includes items A, B, C and D and dynamically generating an ensemble that is personalized for the second customer that includes items A, E, F and G.

According to one embodiment, the initial inputs 4010 to the collection recommendation system 120 include the inputs entered on the my account page as depicted on FIG. 6, inputs from the retailer, more general customer inputs, empirical data, and information about other customers that are similar to a customer. One or more of the inputs 4010 are used to build correlation tables, according to one embodiment.

The dynamic recommendation generation component 4070 can receive the initial inputs 4010 and generate an initial combination based on the correlation tables and rules. According to one embodiment, the rules include constraints. An example of a rule is a violation of what would be considered proper style. For example, it is improper style to mix stripes and checks or to combine certain types of colors. In another example, different types of clothing look better on different shapes and sizes of bodies. More specifically, a tall athletic woman and a short woman with an hour glass figure look better in different types of clothing. A tall woman may look good wearing a jacket with large lapels whereas a short woman may look good wearing a jacket with a zipper down the front instead of lapels. A tall thin person may look good wearing horizontal stripes and a short person would look better wearing vertical stripes instead of horizontal stripes. According to one embodiment, types of collections with respectively associated categories of items can be used as a part of dynamically generating recommendations of personalized ensembles.

According to one embodiment, there is a feedback loop that enables subsequent recommendations to be dynamically generated based on subsequent inputs 4010 to the collection recommendation system 120. For example, the collection recommendation system 120 can iteratively generate subsequent recommendations in response to additional inputs 4010 that are received and re-rank the subsequent recommendations, as discussed herein. The subsequent recommendation for an iteration of the feedback loop may be the same as the previous recommendations, entirely different than the previous recommendations, or contain a subset of items or a subset of recommendation of the previous recommendations.

The subsequent inputs 4010 can be used to modify the correlation tables and the dynamic recommendation generation component 4070 can use the modified correlation tables and the rules as a part of dynamically generating subsequent recommendations.

Examples of subsequent inputs include finer grained customer inputs pertaining to customers' preferences on individual items, selections of alternative items, requests to generate a new collection, add to a collection, or suggest a collection, the customer's likes and dislikes, among other things. Further subsequent recommendations can be dynamically generated based on subsequent input from retailers, customer input whether general or fine grained, preferences on individual items, additional empirical data, additional information about other customers that are similar to the customer.

One or more of the recommendations 4040 are displayed, for example, for the customer to view. The recommendations 4040 may be a hierarchy of recommendations, as discussed herein.

Initially, the collection recommendation system 120 can using a base line of recommendations that have been provided, for example, by one or more retailers. For example, the collection recommendation system 120 can receive input 4010 specifying a baseline of recommendations that are stored 4090b in the stored recommendations 4080. The base line of recommendations may be based on mannequin cards. With each iteration of dynamically generating recommendations and receiving additional inputs 4010 pertaining to the customer, the baseline recommendations can be replaced with recommendations that are personalized ensembles. For example, for each iteration, the previous recommendations are obtained 4090a from the stored recommendations 4080, new recommendations are generated based at least in part on the previous recommendations and the previous recommendations are replaced by storing 4090b the newly generated recommendations in the stored recommendations 4080 in preparation for the next iteration. The output providing component 4030 can display the stored recommendations 4080 as output 4040 to the user. Over time, the baseline of recommendations can be replaced with recommendations that are personalized. According to one embodiment, the stored recommendations 4080 are re-prioritized for each iteration.

According to one embodiment, a user can upload a picture of an item that is not offered by a retailer (referred to herein as “non-retailer-offered item”) and dynamically generate a recommendation that includes the item, where the items associated with the recommendation coordinate with the item and provide a personalized ensemble. For example, the user could take a picture or digital image of an item in their physical closet, an item in a magazine, an item of a friend, an item of a stranger, and upload that item. According to one embodiment, the non-retailer-offered item is not a part of the closet 610c of the collection recommendation system 120. According to one embodiment, the non-retailer-offered item can be added to the closet 610c after the image of the non-retailer-offered item is received by the collection recommendation system.

According to one embodiment, an idea for a gift for a person other than the customer, such a friend of the customer, can be generated, for example, based on input or analyzed input. For example, as the customer collection recommendation system receives input and analyzes the input for a customer, it can build a profile and build a list of gift ideas for the customer's friend. The list could include items that complement items purchased by the customer or complement items purchased by other customers that are similar to the customer. The term “third party” can be used to describe the person that is other than the customer. The list of gift ideas could be used as automated wedding registry or party gift ideas that are highly relevant to the friend or third party.

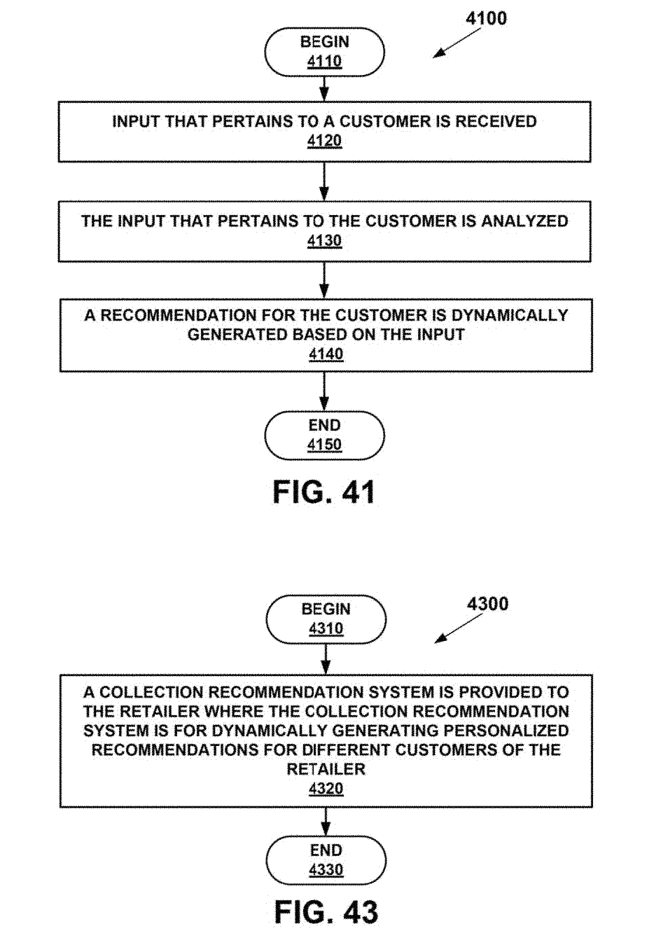

FIG. 41 depicts a flow chart of a method for enhancing a retailer's revenue by making a recommendation to a customer, according to one embodiment.

Although specific operations are disclosed in flow chart 4100, such operations are exemplary. That is, embodiments of the present invention are well suited to performing various other operations or variations of the operations recited in flow chart 4100. It is appreciated that the operations in flow chart 4100 may be performed in an order different than presented, and that not all of the operations in flow chart 4100 may be performed.

The following description shall refer to FIGS. 1 and 40.

At 4110, the method begins.

At 4120, input 4010 that pertains to a customer 140 is received. For example, the input 4010 can be received by an input receiving component 4020 associated with a collection recommendation system 120. The customer 140 may be a human customer or a hypothetical customer.

At 4130, the input 4010 that pertains to the customer 140 is analyzed. For example, the input 4010 can be analyzed by an analysis component 4060 associated with the collection recommendation system 120.

At 4140, a recommendation for the customer 140 is dynamically generated based on the input. For example, the recommendation for the customer 140 includes a collection of coordinated items that provides a personalized ensemble. For example, one or more recommendations 4080 can be dynamically generated by a dynamic recommendation generation component 4070 associated with the collection recommendation system 120. The one or more dynamically generated recommendations 4080 can be output by an output providing component 4030 as outputted recommendations 4040 that can, for example, be displayed to a user, such as a customer 140, among other things. Various embodiments are well suited to other types of users, such as live personal shoppers that are helping a customer 140, a retailer 130 that, for example, are determining preferences of customers 140 as a part of designing items for one or more subsequent seasons, a person that is designing ensembles for marketing materials, among other things.

At 4150, the method ends.

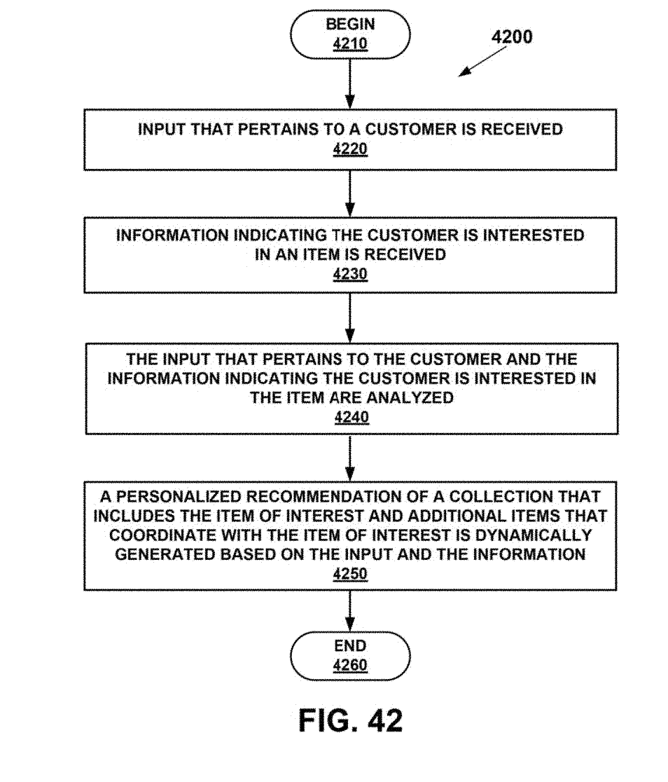

FIG. 42 depicts a flow chart of a method of enhancing a retailer's revenue by making a recommendation to a customer, according to one embodiment.

Although specific operations are disclosed in flow chart 4200, such operations are exemplary. That is, embodiments of the present invention are well suited to performing various other operations or variations of the operations recited in flow chart 4200. It is appreciated that the operations in flow chart 4200 may be performed in an order different than presented, and that not all of the operations in flow chart 4200 may be performed.

At 4210, the method begins.

At 4220, input 4010 that pertains to the customer 140 is received. For example, the input 4010 can be received by an input receiving component 4020 associated with a collection recommendation system 120. The customer 140 may be a human customer or a hypothetical customer. The input 4010 may include an image of an item that is not offered by the retailer 130. For example, the received input 4010 may include a picture or digital image of an item in a customer's physical closet, an item in a magazine, an item of a friend, an item of a stranger, and upload that item.

At 4230, information indicating the customer 140 is interested in an item is received. For example, by receiving a picture or digital image of an item that is not offered by the retailer 130, the collection recommendation system 120 can determine that it is an item of interest to the customer 140. In another example, by clicking on an item 1310 the collection recommendation system 120 can determine that the item 1310 is of interest to the customer 140. IN yet another example, by selecting an option in relation to an item, such as an option 1510, 1520, 1530 of a menu 1540 (FIG. 15), the collection recommendation system 120 can determine that the item 1310 is of interest to the customer 140. These are just a couple possible ways for determining that an item is of interest to a customer 140.

At 4240, the input that pertains to the customer and the information indicating the customer is interested in the item are analyzed. For example, the input 4010 and the information indicating customer interest can be analyzed by an analysis component 4060 associated with the collection recommendation system 120.

At 4250, a personalized recommendation of a collection that includes the item of interest and additional items that coordinate with the item of interest is dynamically generated based on the input and the information. For example, the recommendation for the customer 140 includes a collection of coordinated items that provides a personalized ensemble. For example, one or more recommendations 4080 can be dynamically generated by a dynamic recommendation generation component 4070 associated with the collection recommendation system 120. The one or more dynamically generated recommendations 4080 can be output by an output providing component 4030 as outputted recommendations 4040 that can, for example, be displayed to a user, such as a customer 140, among other things. Various embodiments are well suited to other types of users, such as live personal shoppers that are helping a customer 140, a retailer 130 that, for example, are determining preferences of customers 140 as a part of designing items for one or more subsequent seasons, a person that is designing ensembles for marketing materials, among other things.

At 4260, the method ends.

FIG. 43 depicts a flow chart of a method of enhancing a retailer's revenue by making a recommendation to a customer, according to one embodiment.

Although specific operations are disclosed in flow chart 4300, such operations are exemplary. That is, embodiments of the present invention are well suited to performing various other operations or variations of the operations recited in flow chart 4300. It is appreciated that the operations in flow chart 4300 may be performed in an order different than presented, and that not all of the operations in flow chart 4300 may be performed.

At 4310, the method begins.

At 4320, a collection recommendation system 120, as described herein, is provided to the retailer 130 where the collection recommendation system 120 is for dynamically generating personalized recommendations for different customers 140 of the retailer 130.

At 4330, the method ends.

The above illustration of the flow charts 4100, 4200, 4300 are only provided by way of example and not by way of limitation.

Various embodiments can be provided to provide a retail merchant with insights into customer preferences. For example, various pieces of information that one or more customers inputted into a recommendation collection system, such as their style preferences, color preferences, their likes, dislikes, the displayed items that they selected, the displayed items that they did not select, can be used to determine insights into customer preferences. The retail merchant can use these insights as a part of designing what items to manufacture for subsequent seasons.

Any one or more of the embodiments described herein can be implemented using non-transitory computer readable storage medium and computer-executable instructions which reside, for example, in computer-readable storage medium of a computer system or like device. The non-transitory computer readable storage medium can be any kind of memory that instructions can be stored on. Examples of the non-transitory computer readable storage medium include but are not limited to a disk, a compact disk (CD), a digital versatile device (DVD), read only memory (ROM), flash, and so on. As described above, certain processes and operations of various embodiments of the present invention are realized, in one embodiment, as a series of instructions (e.g., software program) that reside within non-transitory computer readable storage memory of a computer system and are executed by the computer processor of the computer system. When executed, the instructions cause the computer system to implement the functionality of various embodiments of the present invention. According to one embodiment, the non-transitory computer readable storage medium is tangible.

The conventional art lacks access to the amount of information, the types of information used for various embodiments and lacks the processing power to analyze the amount of information. Therefore, the convention art is unable to dynamically generated a personalized ensemble and cannot teach or suggest a method or system of dynamically generating a personalized ensemble. Further, the conventional art cannot teach or suggest a method or system of dynamically generating, based on the input, a recommendation for the customer that includes a collection of coordinated items that provides a personalized ensemble. Further still, for these reasons, the conventional art is unable to provide a cost effective near real time method or system for dynamically generating, based on the input, a recommendation for the customer that includes a collection of coordinated items that provides a personalized ensemble. According to one embodiment, an efficient cost effective rules based near real time approach of dynamically generating a personalized ensemble is used in contrast to an inefficient, expensive, subjective, intuitive, slow approach provided by a live personal shopper.

Although various embodiments are illustrated with a customer interacting with a user interface of a collection recommendation system, various embodiments are well suited for other types of users interacting with the user interface, such as a personal shopper, a retailer, a publisher, among others. Various embodiments are illustrated with items of apparel. However, various embodiments are well suited to other types of items, such as items of furniture. For example, various embodiments are well suited for dynamically generating a collection of furniture items that provide a recommendation of a personalized ensemble of furniture for a room. Various embodiments are well suited for generating recommendations for hypothetical customers that can be published, for example, in a magazine or on a web page, among others.

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments have been described in various combinations and illustrations. However, any two or more embodiments or features may be combined. Further, any embodiment or feature may be used separately from any other embodiment or feature. Phrases, such as “an embodiment,” “one embodiment,” among others, used herein, are not necessarily referring to the same embodiment. Features, structures, or characteristics of any embodiment may be combined in any suitable manner with one or more other features, structures, or characteristics.

What is claimed is:

1. A device, comprising:
a memory storing instructions;
one or more processors, executing the instructions, to:
access an inventory database of a retailer, the inventory database comprising an inventory of items available for sale by the retailer;
access a customer database of the retailer, the customer database comprising:
a list of customers known to the retailer, and
at least one item purchased by each customer on the list; and
dynamically generate, based on the inventory of items available for sale by the retailer and data from the customer database, a different personalized ensemble recommendation for at least two different customers,
each different personalized ensemble recommendation comprising a plurality of items available for sale by the retailer; and
a display to present the different personalized ensemble recommendation to the at least two different customers in an interactive environment.

2. The device of claim 1, where the one or more processors are further to:
receive, from a first customer of the at least two different customers, a selection of at least one item from the personalized ensemble recommendation.

3. The device of claim 2, where the one or more processors are further to:
dynamically generate, based on the inventory of items available for sale by the retailer and the received selection of the at least one item, a new personalized ensemble recommendation for the first customer; and
present the new personalized ensemble recommendation to the first customer.

4. The device of claim 1, where the one or more processors are further to:
provide, to the at least two different customers, a drop down menu in conjunction with the presentation of the different personalized ensemble recommendation to the at least two different customers,
the drop down menu providing a number of different categories that can be selected by either of the at least two different customers to adjust the personalized ensemble recommendation.

5. The device of claim 4, wherein the number of different categories are selected from the group consisting of: a price, a color, a shirt, a pant, a dress, a shoe, a handbag, a coat, a tie, a jacket, a sweater, and an accessory.

6. The device of claim 4, where the one or more processors are further to:
receive, from a first customer of the at least two different customers, a selection from the drop down menu.

7. The device of claim 6, where the one or more processors are further to:
dynamically generate, based on the inventory of items available for sale by the retailer and the received selection from the drop down menu, a new personalized ensemble recommendation for the first customer;
present the new personalized ensemble recommendation to the first customer; and
provide, to the first customer, a modified drop down menu in conjunction with the presentation of the new personalized ensemble recommendation.

8. A non-transitory computer-readable medium storing instructions, the instructions comprising:
one or more instructions that, when executed by one or more processors, cause the one or more processors to:
one or more processors, executing the instructions, to:
access an inventory database of a retailer, the inventory database comprising an inventory of items available for sale by the retailer;
access a customer database of the retailer, the customer database comprising:
a plurality of customers known to the retailer, and
at least one item purchased by each of the plurality of customers;
dynamically generate, based on the inventory of items available for sale by the retailer and data from the customer database, a plurality of personalized ensemble recommendations for each of the plurality of the customers,
each of the personalized ensemble recommendations comprising a plurality of items available for sale by the retailer; and
present at least one of the plurality of personalized ensemble recommendations to at least one of the plurality of customers in an interactive environment.

9. The computer-readable medium of claim 8, where the one or more instructions, when executed by the one or more processors, further cause the one or more processors to:
receive, from at least one of the plurality of customers, a selection of at least one item from the at least one of the plurality of personalized ensemble recommendations presented to at least one of the plurality of customers.

10. The computer-readable medium of claim 9, where the one or more instructions, when executed by the one or more processors, further cause the one or more processors to:
dynamically generate, based on the inventory of items available for sale by the retailer and the received selection of the at least one item, a new personalized ensemble recommendation for the at least one of the plurality of customers; and
present the new personalized ensemble recommendation to at least one of the plurality of customers.

11. The computer-readable medium of claim 8, where the one or more instructions, when executed by the one or more processors, further cause the one or more processors to:
provide, to the at least one of the plurality of customers, a drop down menu in conjunction with the presentation of the at least one of the plurality of personalized ensemble recommendations to at least one of the plurality of customers,
the drop down menu providing a number of different categories that can be selected by at least one of the plurality of customers to adjust the personalized ensemble recommendations.

12. The computer-readable medium of claim 11, wherein the number of different categories are selected from the group consisting of: a price, a color, a shirt, a pant, a dress, a shoe, a handbag, a coat, a tie, a jacket, a sweater, and an accessory.

13. The computer-readable medium of claim 11, where the one or more instructions, when executed by the one or more processors, further cause the one or more processors to:
receive, from at least one of the plurality of customers known, a selection from the drop down menu.

14. The computer-readable medium of claim 13, where the one or more instructions, when executed by the one or more processors, further cause the one or more processors to:
dynamically generate, based on the inventory of items available for sale by the retailer and the received selection from the drop down menu, a new personalized ensemble recommendation for the at least one of the plurality of customers;
present the new personalized ensemble recommendation to at least one of the plurality of customers; and
provide, to the at least one of the plurality of customers, a modified drop down menu in conjunction with the presentation of the new personalized ensemble recommendation.

15. A method, comprising:
accessing a collection recommendation system operating on a computing device of a retailer;
accessing a customer database of the retailer, the customer database comprising:
a list comprising a plurality of customers known to the retailer, and
a virtual closet comprising at least one item purchased by each of a plurality of customers;
providing the at least one item purchased by each of the plurality of customers to the collection recommendation system;
accessing an inventory database of a retailer, the inventory database comprising an inventory of items available for sale by the retailer;
providing the inventory of items available for sale by the retailer to the collection recommendation system;
dynamically generating, by the collection recommendation system and based on the at least one item purchased by each of the plurality of customers and the inventory of items available for sale by the retailer, at least one personalized ensemble recommendation for each of the plurality of customers,
the personalized ensemble recommendation comprising a plurality of the items available for sale by the retailer; and
presenting, on a display, the at least one personalized ensemble recommendation to at least one of the plurality of customers in an interactive environment.

16. The method of claim 15, wherein the at least one item purchased by each of a plurality of customers was purchased from the retailer.

17. The method of claim 15, further comprising:
receiving feedback from one or more of the plurality of customers in response to the presenting of the at least one personalized ensemble recommendation.

18. The method of claim 17, further comprising:
dynamically modifying, by the collection recommendation system and based on the feedback from one or more of the plurality of customers, the at least one personalized ensemble recommendation to generate at least one modified personalized ensemble recommendation for each of the plurality of customers; and
presenting the at least one modified personalized ensemble recommendation to at least one of the plurality of customers.

19. The method of claim 15, wherein the collection recommendation system further comprises:
utilizing at least one mannequin card when dynamically generating the at least one personalized ensemble recommendation; and
utilizing a correlation table and one or more predefined style rules when dynamically generating the at least one personalized ensemble recommendation.

20. The method of claim 15, further comprising:
providing, to the at least one of the plurality of customers, a drop down menu in conjunction with the presentation of the at least one personalized ensemble recommendation to at least one of the plurality of customers,
the drop down menu providing a number of different categories that can be selected by at least one of the plurality of customers to adjust the personalized ensemble recommendations.
